(19) United States
(12) Patent Application Publication
(10) Pub. No.: US 2010/0206959 A1
(43) Pub. Date: Aug. 19, 2010

(54) CHEMICAL SUBSTANCE CONCENTRATION METHOD

(75) Inventors: Akio OKI, Kyoto (JP); Hiroaki OKA, Osaka (JP)

Correspondence Address: McDERMOTT WILL & EMERY LLP, 600 13th Street, N.W., Washington, DC, 20005-3096, US

(73) Assignee: PANASONIC CORPORATION, Osaka (JP)

(21) Appl. No.: 12/648,214

(22) Filed: Dec. 28, 2009

Related U.S. Application Data
(63) Continuation of application No. PCT/JP2009/065985, filed on Sep. 8, 2009.

(30) Foreign Application Priority Data
Feb. 19, 2009 (JP) 2009-036167

(51) Int. Cl. B05B 5/025

(52) U.S. Cl. 239/3

(57) ABSTRACT

An electrostatic spraying device for use in a chemical substance concentrating method, where the device includes a vessel, an injection port, a cooling part, an atomizing electrode section, and a unit for recovery of the chemical substance in the counter electrode section. Furthermore, the chemical substance concentration method includes the steps of: injecting a sample gas; producing a first condensate liquid from the sample gas; producing first charged fine particles from the first condensate liquid; producing second charged fine particles by mixing the first charged fine particles with the sample gas; and recovering the first charged fine particles and the second charged fine particles. According to a series of the operation described above, the chemical substances in the sample gas can be concentrated in a simple and efficient manner.

### TECHNICAL FIELD

The present disclosure relates to a chemical substance concentration method for efficiently concentrating a variety of chemical substances included in a sample gas.

### BACKGROUND ART

In recent years, ultramicro analyses have been enabled since an atmospheric pressure ionization (API) method was developed. There are two main atmospheric pressure ionization methods.

One is an electrospray ionization (ESI) method. In the electrospray ionization method, a sample solution is first introduced into a capillary to which a high voltage of several kV has been applied. Then the sample solution is sprayed from the capillary tip by a nebulizer gas flow provided from the external side of the capillary. In this step, the sample solution forms a large number of charged droplets. The charged droplets undergo solvent evaporation and disruption repeatedly. Consequently, the sample ion is released into the gas phase, which sample ion is subjected to a mass spectrometry in many cases.

Another method is an atmospheric pressure chemical ionization (APCI) method. In the atmospheric pressure chemical ionization method, a sample solution is first sprayed with a nebulizer gas in a heater. Then, vaporization of the solvent and the sample molecules is allowed. Next, the sample molecules are ionized by corona discharge to turn into reactant ions. Proton transfer occurs between the reactant ion and the sample molecule, whereby the sample molecule turns into an ion through proton addition or proton desorption.

For example, as a mass spectrometer for use in employing an atmospheric pressure ionization method, an atmospheric pressure ionization mass spectrometer (APIMS) may be utilized (see, Patent Document 1). FIG. 19 shows the atmospheric pressure ionization mass spectrometer disclosed in Patent Document 1.

Ar gas 1 for primary ion generation is introduced into an ion generating unit 15, and then ionized with a needle electrode 19 to produce a primary ion not including NOₓ. The primary ion is introduced into a mixing unit 30 along with the gas 1 for primary ion generation, and mixed with a dry air that is a sample gas 2. In the mixing unit 30, the dry air is ionized by an ion-molecule reaction with the primary ion. The ionized sample gas 2 is introduced into mass spectrometry unit 11 and analyzed. NOₓ included in the ambient air or exhaled breath is analyzed with an APIMS 10.

Conventional atmospheric pressure ionization methods require a nebulizer gas or a gas for primary ion generation. Therefore, a large-scale atmospheric pressure ionization apparatus is necessary, and the operation becomes complicated. Thus, for downsizing the atmospheric pressure ionization apparatus and for simplifying the operation, a method for ionization of sample molecules under an ambient pressure without using a nebulizer gas or a gas for primary ion generation was proposed (see, Patent Document 2 and Patent Document 3).

An atmospheric pressure ionization apparatus in which a nebulizer gas and a gas for primary ion generation are not used is disclosed in Patent Document 2. In this apparatus, a solvent in the mist is vaporized by electrostatic spraying of a nonvolatile dilute solution of biomolecules. In Patent Document 2, it is disclosed that this method can be utilized as a means for microconcentration of a dilute solution of biomolecules by depositing biomolecules on a substrate with an electrostatic spraying method.

Furthermore, an atmospheric pressure ionization apparatus in which neither a nebulizer gas nor a gas for primary ion generation is used is disclosed in Patent Document 3. In an electrostatic atomizing apparatus provided with: a discharge electrode; a counter electrode positioned opposite to the discharge electrode and a supplying means for supplying water to the discharge electrode, in which water retained at the discharge electrode is atomized by applying a high voltage between the discharge electrode and the counter electrode, a water supply means is employed as a water generation means for generating water at the discharge electrode zone by virtue of moisture in the air.

### CITATION LIST

### Patent Literature

{PTL 1} JP-A No. Hei 11-273615 (page 8, FIG. 1)

{PTL 2} JP-T (Japanese Translation of PCT International Publication) No. 2002-511792 (page 78, FIG. 9)

{PTL 3} JP-A No. 2005-296753 (page 10, FIG. 1)

### SUMMARY OF INVENTION

### Technical Problem

Any of the conventional apparatuses disclosed in Patent Document 2 and Patent Document 3 will function as an atmospheric pressure ionization apparatus in which a nebulizer gas and a gas for primary ion generation are not used. However, when such a conventional apparatus is employed for concentration of chemical substances in a sample gas, satisfactory efficiency of the concentration may not be obtained depending on the chemical substance. This problem is particularly relevant in the case of volatile chemical substances.

According to the present disclosure, in order to solve the foregoing problems of the prior arts, a method for simply and efficiently concentrating chemical substances in a sample gas by electrostatic spraying without using a nebulizer gas and a gas for primary ion generation is provided.

### Solution to Problem

In one aspect of the present disclosure for solving the foregoing conventional problems, a chemical substance concentration method carried out using an electrostatic spraying device is provided, the electrostatic spraying device including a vessel, an injection port of a sample gas in communication with the vessel, a cooling part provided at one end of the vessel, an atomizing electrode section provided at one end of the cooling part, a counter electrode section provided inside the vessel, a chemical substance recovery unit provided at the other end of the vessel, and a supply port of a dopant in communication with the vessel, in which: the sample gas includes water vapor and a chemical substance; the chemical substance is capable of forming a condensate liquid together with the water vapor at a temperature no higher than the dew-point of the water vapor; the dopant is a substance that is dissolved into the condensate liquid; and the electric affinity of the dopant is greater than the electronic affinity of water, the method including: an injection step for injecting the sample gas from the injection port to the vessel; a first condensate liquid formation step for forming a first condensate liquid from the sample gas on the outer peripheral surface of the atomizing electrode section by cooling the atomizing electrode section with the cooling part; a supplying step for supplying the dopant from the supply port to the vessel; a dopant cooling step for cooling the dopant on the outer peripheral surface of the atomizing electrode section; a dissolving step for dissolving the dopant in the first condensate liquid; a charged fine particle production step for producing charged fine particles from the first condensate liquid; and a recovery step for recovery of the charged fine particle into the chemical substance recovery unit.

In the present disclosure, the dopant is preferably a polar organic compound.

In the present disclosure, the dopant is preferably an organic acid.

In the present disclosure, the dopant is preferably acetic acid.

In the present disclosure, the dopant is preferably oxygen.

In the present disclosure, the concentration of the dopant in the first condensate liquid is preferably higher than the concentration of the chemical substance in the first condensate liquid.

In the present disclosure, the vessel is preferably provided with a barrier at a position onto which the sample gas hits.

In the present disclosure, the sample gas preferably includes a polar organic solvent.

In the present disclosure, the chemical substance is preferably a polar organic compound.

In the present disclosure, the chemical substance is preferably a volatile organic compound.

In the present disclosure, the charged fine particles are preferably heated by infrared light.

In the present disclosure, the vessel is preferably provided with an optical waveguide.

In the present disclosure, the electrostatic spraying device is preferably provided with a chemical substance detection unit.

The objects described in the foregoing, other objects, features and advantages of the present disclosure will be apparent from the following detailed description of preferred embodiments with reference to attached drawings.

### ADVANTAGEOUS EFFECTS OF INVENTION

According to the chemical substance concentration method of the present disclosure, necessity of a nebulizer gas and a gas for primary ion generation can be avoided which have been essential in conventional atmospheric pressure ionization methods because the sample gas is condensed on the outer peripheral surface of the cooled atomizing electrode section, and the condensate liquid is electrostatically sprayed. Thus, secondary ionization of the sample gas is achieved by mixing the sample gas with a primary ion, the primary ion being provided in the form of sprayed charged fine particles.

In addition, since both the primary ion and the secondary ion are recovered into the chemical substance recovery unit, efficient concentration of the chemical substance is enabled. Moreover, since a dopant is mixed into the sample gas, production of the charged fine particles can be facilitated. As a consequence, the chemical substance can be efficiently concentrated. Therefore, chemical substances can be concentrated simply and efficiently using an electrostatic spraying device according to the chemical substance concentration method of the present disclosure.

### BRIEF DESCRIPTION OF DRAWINGS

FIG. 1 shows an exemplary schematic diagram illustrating an electrostatic spraying device according to Embodiment 1;

FIG. 2 (a) shows an exemplary explanatory view illustrating an injection step in the electrostatic spraying device according to Embodiment 1; and FIG. 2 (b) shows an explanatory view illustrating a first condensate liquid formation step in the electrostatic spraying device according to Embodiment 1;

FIG. 3 (a) shows an explanatory view illustrating a supplying step in the electrostatic spraying device according to Embodiment 1; and FIG. 3 (b) shows an exemplary explanatory view illustrating a dopant cooling step in the electrostatic spraying device according to Embodiment 1;

FIG. 4 (a) shows an exemplary explanatory view illustrating a dissolving step in the electrostatic spraying device according to Embodiment 1; and FIG. 4 (b) shows an exemplary explanatory view illustrating a charged fine particle production step in the electrostatic spraying device according to Embodiment 1;

FIG. 5 shows an exemplary explanatory view illustrating a recovery step in the electrostatic spraying device according to Embodiment 1;

FIG. 6 shows an exemplary schematic diagram illustrating an electrostatic spraying device according to Embodiment 2;

FIG. 7 (a) shows an exemplary explanatory view illustrating an injection step in the electrostatic spraying device according to Embodiment 2; and FIG. 7 (b) shows an exemplary explanatory view illustrating a first condensate liquid formation step in the electrostatic spraying device according to Embodiment 2;

FIG. 8 (a) shows an exemplary explanatory view illustrating a supplying step in the electrostatic spraying device according to Embodiment 2; and FIG. 8 (b) shows an exemplary explanatory view illustrating a dopant cooling step in the electrostatic spraying device according to Embodiment 2;

FIG. 9 (a) shows an exemplary explanatory view illustrating a dissolving step in the electrostatic spraying device according to Embodiment 2; and FIG. 9 (b) shows an exemplary explanatory view illustrating a first charged fine particle production step in the electrostatic spraying device according to Embodiment 2;

FIG. 10 (a) shows an exemplary explanatory view illustrating a second charged fine particle production step in the electrostatic spraying device according to Embodiment 2; and FIG. 10 (b) shows an exemplary explanatory view illustrating a recovery step in the electrostatic spraying device according to Embodiment 2;

FIG. 11 shows an exemplary schematic diagram illustrating an electrostatic spraying device according to Embodiment 3;

FIG. 12 shows an exemplary schematic diagram illustrating an electrostatic spraying device according to Embodiment 4;

FIG. 13 shows a micrograph taken for illustrating the state of formation of a first condensate liquid on the outer peripheral surface of an atomizing electrode section in Example 1;

FIG. 14 (a) shows a micrograph taken for illustrating a Taylor cone formed on the tip of the atomizing electrode section in Example 1; and FIG. 14 (b) shows a schematic view provided by tracing the micrograph shown in FIG. 14 (a);

FIG. 15 shows a micrograph taken for illustrating an outer peripheral surface of a chemical substance recovery unit in Example 1;

FIG. 16 shows a view illustrating analytical results of a recovered liquid in Example 1;

FIG. 17 shows an enlarged view illustrating a part of the view shown in FIG. 16;

FIG. 18 shows a view illustrating analytical results of a recovered liquid in Example 2; and

FIG. 19 shows a schematic view illustrating a conventional atmospheric pressure ionization mass spectrometer.

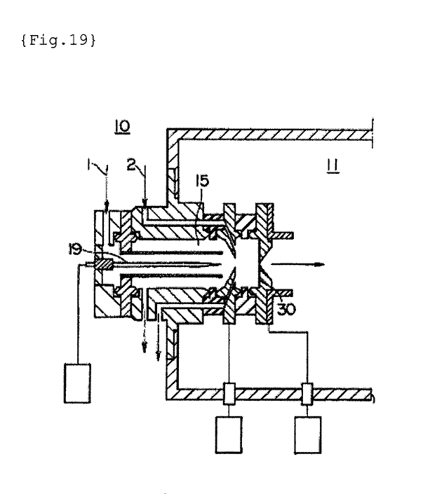

### DESCRIPTION OF EMBODIMENTS

Hereinafter, Embodiments of the present disclosure will be explained with appropriate reference to the drawings.

### Embodiment 1

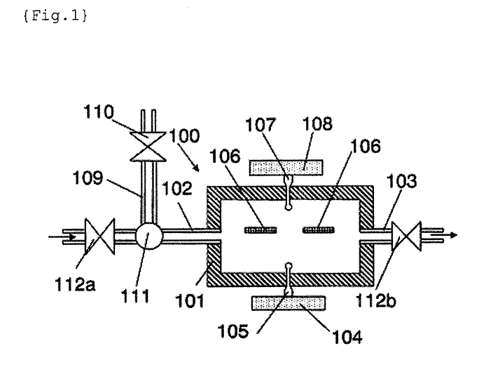

FIG. 1 shows an exemplary schematic diagram illustrating an electrostatic spraying device according to Embodiment 1.

In the present Embodiment, a method for electrostatic spray of sample gas may be carried out in a substantially similar manner to the method disclosed in Japanese Patent Application No. 2008-024667 and Japanese Patent Application No. 2007-279875 filed in the name of the same inventor(s) as that (those) of the present application.

The most prominent difference from the methods disclosed in Japanese Patent Application No. 2008-024667 and Japanese Patent Application No. 2007-279875 is that a dopant is added to a condensate liquid.

The dopant is added for the purpose of acceleration of formation of charged fine particles in the condensate liquid. By adding the dopant, the sample gas can be efficiently concentrated. The electronic affinity of the dopant is greater than the electronic affinity of water. The electronic affinity referred to herein means an energy released when an electron is applied to a neutral atom or a neutral molecule. Therefore, the dopant is more likely to receive an electron than water. As a result, the condensate liquid that contains the dopant can readily form charged fine particles.

Hereinafter, an electrostatic spraying device 100 having a system for adding the dopant to the condensate liquid is explained. For reference, details of the electrostatic spraying device 100 are described in Japanese Patent Application No. 2008-024667 and Japanese Patent Application No. 2007-279875.

A vessel 101 is separated from the outside by means of a partition wall. Any substance runs from/to the outside through the partition wall. The vessel 101 may have a shape of either a rectangular solid, or may be any one of polyhedra, spindles, spheres, and flow paths. It is preferred that retention of the sample gas in a part of the vessel 101 can be prevented. The volume of the vessel 101 is preferably no less than 10 pL and no greater than 100 mL. The volume of the vessel 101 is more preferably no less than 1 mL, and no greater than 30 mL.

The material of the vessel 101 is desirably accompanied by less adsorption gas or included gas. The material of the vessel 101 is most preferably a metal. The metal is preferably stainless; however, aluminum, brass, copper-zinc alloys, and the like are also acceptable.

The material of the vessel 101 may also be an inorganic material. The material of the vessel 101 may also be glass, silicon, alumina, sapphire, quartz glass, borosilicic acid glass, silicon nitride, alumina, silicon carbide, or the like. The material of the vessel 101 may be one produced by covering a silicon substrate with silicon dioxide or silicon nitride, or tantalum oxide.

The material of the vessel 101 may also be an organic material. The material of the vessel 101 may be acryl, polyethylene terephthalate, polypropylene, polyester, polycarbonate, fluorine resin, polydimethyl siloxane, PEEK (registered trademark), Teflon (registered trademark), or the like. When an organic material is used as the material of the vessel 101, the outer peripheral surface of the vessel 101 is more preferably coated with a metal thin film. As the metal thin film, a material having superior gas barrier properties is preferred.

The material of the vessel 101 may be one of the materials described in the foregoing, or any combination of multiple materials identified above.

Although the vessel 101 is preferably hard, it may be soft as in the case of an air bag, balloon, flexible tube, syringe or the like.

An injection port 102 is provided so as to be in communication with the vessel 101. The injection port 102 is used for injecting the sample gas into the vessel 101. It is preferred that the injection port 102 be provided at a position enabling the sample gas to be rapidly injected into the vessel 101, or a position enabling the sample gas to be injected uniformly into the vessel 101.

The injection port 102 preferably has a shape that enables the sample gas to be uniformly injected into the vessel 101. The injection port 102 may also have a large number of through-holes like an air shower device. In the present disclosure, the size and the material of the injection port 102 are not limited. The shape of the injection port 102 may be of a straight tube as shown in FIG. 1, or may be provided with a branched portion along the path. Also, the injection port 102 may be provided either at one site, or at multiple sites, each of which is in communication with the vessel 101.

An outlet port 103 is provided at the other end of the vessel 101. The outlet port 103 is used for discharging the excess sample gas from the sample gas filled in the vessel 101. The outlet port 103 is preferably provided at a position enabling the sample gas filled in the vessel 101 to be rapidly discharged. In the present disclosure, the shape, the size and the material of the outlet port 103 are not limited. The shape of the outlet port 103 may be of a straight tube as shown in FIG. 1, or may be provided with a branched portion along the path. Also, the outlet port 103 may be provided either at one site, or at multiple sites, each of which is in communication with the vessel 101.

A cooling part 104 is provided at one end of the vessel 101. The cooling part 104 enables the sample gas to be cooled to a temperature no higher than the dew-point of water vapor. The cooling part 104 is most preferably a thermoelectric element; however, a heat pipe in which a refrigerant is used, a heat air transfer element, or a cooling fan or the like may also be acceptable. The area of the cooling part 104 is preferably small, but must be sufficient in size to cool the electrode. In addition, also in light of reduction of the electric power consumption, the area of the cooling part 104 is preferably as small as possible.

For the purpose of efficiently cooling the electrode, a relief structure is preferably provided on the surface of the cooling part 104. A porous material may be also provided on the surface of the cooling part 104. The position of the cooling part 104 is most preferably the bottom part of the vessel 101, but may be the lateral part or top part. Alternatively, a plurality of the cooling parts 104 may be also provided at the foregoing positions in combination with one another.

In order to suppress thermal conduction, the contact area of the cooling part 104 with the vessel 101 is preferably small, and specifically, the contact area is preferably no less than 100 μm² and no greater than 5 mm².

An atomizing electrode section 105 is provided at one end of the cooling part 104. The atomizing electrode section 105 is cooled by the cooling part 104 to no higher than the dew-point temperature of water vapor. Although it is preferred that the atomizing electrode section 105 be in direct contact with the cooling part 104, it may be in contact via a material having substantial thermal conductivity. The material having a substantial or large thermal conductivity is preferably a thermal conductive sheet, thermal conductive resin, metal plate, grease, metal paste or the like.

Although the atomizing electrode section 105 is most preferably positioned on the bottom face of the vessel 101, it may be also positioned on the lateral face of the vessel 101, or may be positioned on the top or bottom face center portion. Alternatively, the atomizing electrode section 105 may be positioned no less than 10 mm away from the lateral face of the vessel 101. The tip of the atomizing electrode section 105 is preferably directed upward.

The shape of the atomizing electrode section 105 is preferably needle-like. The length of the needle is preferably no less than 3 mm and no greater than 10 mm. The atomizing electrode section 105 may be solid, hollow, or porous. A relief structure or a groove structure may be also provided on the surface of the atomizing electrode section 105. The tip of the atomizing electrode section 105 may be provided with a spherical protrusion. The whole of the atomizing electrode section 105 is preferably cooled to no higher than the dew-point temperature of water vapor.

The material of the atomizing electrode section 105 is preferably a good thermal conductive material, and most preferably a metal. The metal may be an element metal such as copper, aluminum, nickel, tungsten, molybdenum, titanium, or tantalum, and an alloy or an intermetallic compound including two or more element metals in combination such as, for example, stainless, copper tungsten, copper-zinc alloys, brass, high-speed steel, carbide may be also acceptable.

The material of the atomizing electrode section 105 may be an inorganic material, or may be a semiconductor or a carbon material. For example, LaB₆, SiC, WC, silicon, gallium arsenide, gallium nitride, SiC, a carbon nanotube, graphene, graphite or the like can be used. The material of the atomizing electrode section 105 may be one of the aforementioned materials, or two or more of them may be used in combination.

In order to suppress abrasion of the atomizing electrode section 105, the surface of the atomizing electrode section 105 is preferably covered. In order to facilitate transfer of electrons between the surface of the atomizing electrode section 105 and the condensate liquid, the surface of the atomizing electrode section 105 is preferably covered. The material for covering the atomizing electrode section 105 is preferably a metal, a semiconductor, an inorganic material or the like. As the material for covering the atomizing electrode section 105, gold, platinum, aluminum, nickel, chromium, a semiconductor, a carbon material, LaB₆, SiC, WC, silicon, gallium arsenide, gallium nitride, SiC, a carbon nanotube, graphene, graphite or the like can be used. The material for covering the atomizing electrode section 105 may be a single layer of the aforementioned material, or may be a laminate of two or more of them.

The number of the atomizing electrode section 105 may be one, or two or more. When the atomizing electrode section 105 is provided in the number of two or more, they may be arranged one-dimensionally like linear, two-dimensionally like circular, parabolic, elliptic, square lattice-like, orthorhombic lattice-like, closest packed lattice-like, radial, random or the like, or may be arranged three-dimensionally like spherical, parabolic, oblate sphere, or the like.

The surface of the atomizing electrode section 105 is preferably hydrophilic, but may be also water-repellent.

A counter electrode section 106 is provided inside the vessel 101. A high voltage is applied between the counter electrode section 106 and the atomizing electrode section 105, and the condensate liquid is sprayed. The shape of the counter electrode section 106 is most preferably toric. When the counter electrode section 106 is toric, the external diameter of the counter electrode section 106 is preferably no less than 10 mm and no greater than 30 mm, while the internal diameter of the counter electrode section 106 is preferably no less than 1 mm and no greater than 9.8 mm, and the thickness of the counter electrode section 106 is preferably no less than 0.1 mm and no greater than 5 mm. The shape of the counter electrode section 106 may be polygonal such as rectangular, trapezoidal or the like.

The shape of the counter electrode section 106 is preferably planer, but may be hemispherical or domal. At the counter electrode section 106, a slit through which the chemical substance passes and a through-hole are preferably formed. In the present disclosure, the shape of the counter electrode section 106 is not limited to the shapes noted above.

The distance between the counter electrode section 106 and the atomizing electrode section 105 is preferably no less than 3 mm and no greater than 10 mm. Also, the counter electrode section 106 may be movable with respect to the vessel 101. When the counter electrode section 106 is toric, the atomizing electrode section 105 is preferably provided on a straight line that passes the center of the counter electrode section 106 and crosses vertically with the plane of the counter electrode section 106.

The counter electrode section 106 is preferably insulated electrically from the vessel 101.

The material of the counter electrode section 106 is preferably a conductor, and most preferably a metal. The metal is preferably an element metal such as copper, aluminum, nickel, tungsten, molybdenum, titanium or tantalum, and an alloy or an intermetallic compound including two or more element metals in combination such as, for example, stainless, copper tungsten, copper-zinc alloys, brass, high-speed steel, carbide may be also acceptable.

The material of the counter electrode section 106 may be an inorganic material, or may be a semiconductor, a carbon material, or an insulator. For example, LaB₆, SiC, WC, silicon, gallium arsenide, gallium nitride, SiC, a carbon nanotube, graphene, graphite, alumina, sapphire, silicon oxide, ceramics, glass, a polymer or the like may be used. The material of the counter electrode section 106 may be one of the aforementioned materials, or two or more of them may be used in combination.

The material of the counter electrode section 106 is preferably a good thermal conductor. It is preferred that the counter electrode section 106 be heated such that an unwanted condensate liquid does not adhere on the surface of the counter electrode section 106. The counter electrode section 106 is preferably heated to no less than the dew-point temperature of water vapor.

In order to suppress abrasion of the counter electrode section 106, the surface of the counter electrode section 106 is preferably covered. The material for covering the counter electrode section 106 is preferably a metal, a semiconductor, an inorganic material or the like. As the material for covering the counter electrode section 106, gold, platinum, aluminum, nickel, chromium, LaB₆, SiC, WC, silicon, gallium arsenide, gallium nitride, a carbon nanotube, graphene, graphite or the like can be used. The material for covering the counter electrode section 106 may be a single layer of the aforementioned material, or may be a laminate of two or more of the aforementioned materials.

The surface of the counter electrode section 106 is preferably hydrophilic, but may also be water-repellent.

The number of the counter electrode section 106 may be one, or two or more. When the counter electrode section 106 is provided in the number of two or more, they may be arranged one-dimensionally like linear, two-dimensionally like circular, parabolic, elliptic, square lattice-like, orthorhombic lattice-like, closest packed lattice-like, radial, random or the like, or may be arranged three-dimensionally like spherical, parabolic, oblate sphere, or the like.

A chemical substance recovery unit 107 is provided at the other end of the vessel 101. The chemical substance recovery unit 107 is used for recovering the chemical substance electrostatically sprayed. The chemical substance recovery unit 107 is preferably cooled by a second cooling part 108 to no higher than the dew-point temperature of water vapor. Although it is preferred that the chemical substance recovery unit 107 be in direct contact with the second cooling part 108, it may be in contact via a material having a great thermal conductivity. The material having a great thermal conductivity is preferably a thermal conductive sheet, thermal conductive resin, metal plate, grease, metal paste or the like.

Although the chemical substance recovery unit 107 is most preferably positioned on the top of the vessel 101, it may be also positioned on the lateral face, the bottom face or the top center part of the vessel 101. Alternatively, the chemical substance recovery unit 107 may be positioned no less than 10 mm away from the lateral face of the vessel 101. The tip of the chemical substance recovery unit 107 is preferably directed downward.

The shape of the chemical substance recovery unit 107 is preferably needle-like. The length of the needle is preferably no less than 3 mm and no greater than 10 mm. The shape of the chemical substance recovery unit 107 may be solid, hollow, or porous. A relief structure or a groove structure may be also provided on the surface of the chemical substance recovery unit 107. The tip of the chemical substance recovery unit 107 may be provided with a spherical protrusion. The whole of the chemical substance recovery unit 107 is preferably cooled to no higher than the dew-point temperature of water vapor.

The material of the chemical substance recovery unit 107 is preferably a good thermal conductive material, and most preferably a metal. The metal is preferably an element metal such as copper, aluminum, nickel, tungsten, molybdenum, titanium, or tantalum, and an alloy or an intermetallic compound including two or more element metals in combination may be also acceptable. For example, stainless, copper tungsten, copper-zinc alloys, brass, high-speed steel, carbide or the like may be acceptable.

The material of the chemical substance recovery unit 107 may be an inorganic material, or may be a semiconductor or a carbon material. For example, LaB₆, SiC, WC, silicon, gallium arsenide, gallium nitride, SiC, a carbon nanotube, graphene, graphite or the like can be used. The material of the chemical substance recovery unit 107 may be one of the aforementioned materials, or two or more of them may be used in combination.

In order to suppress abrasion of the chemical substance recovery unit 107, the surface of the chemical substance recovery unit 107 is preferably covered. In order to facilitate transfer of electrons between the surface of the chemical substance recovery unit 107 and the condensate liquid, the surface of the chemical substance recovery unit 107 is preferably covered. The material for covering the chemical substance recovery unit 107 is preferably a metal, a semiconductor, an inorganic material, a carbon material or the like. As the material for covering the chemical substance recovery unit 107, gold, platinum, aluminum, nickel, chromium, LaB₆, SiC, WC, silicon, gallium arsenide, gallium nitride, a carbon nanotube, graphene, graphite or the like can be used. The material for covering the chemical substance recovery unit 107 may be a single layer of the aforementioned material, or may be a laminate of two or more of them.

The number of the chemical substance recovery unit 107 may be one, or two or more. When the chemical substance recovery unit 107 is provided in the number of two or more, they may be arranged one-dimensionally like linear, two-dimensionally like circular, parabolic, elliptic, square lattice-like, orthorhombic lattice-like, closest packed lattice-like, radial, random or the like. Alternatively, they may be arranged three-dimensionally like spherical, parabolic, oblate sphere, or the like.

The surface of the chemical substance recovery unit 107 is preferably hydrophilic, but may be also water-repellent.

The second cooling part 108 is preferably provided at one end of the chemical substance recovery unit 107. By the second cooling part 108, cooling to no higher than the dew-point temperature of water vapor included in the sample gas is enabled. The second cooling part 108 is most preferably a thermoelectric element; however, a heat pipe in which a refrigerant is used, a heat air transfer element, or a cooling fan or the like may be also acceptable. The area of the second cooling part 108 is preferably small, but must be sufficient in size to cool the electrode. Also in light of reduction of the electric power consumption, the area of the second cooling part 108 is preferably as small as possible.

For the purpose of efficiently cooling the electrode, a relief structure or a porous material may be provided on the surface of the second cooling part 108. The position of the second cooling part 108 is most preferably the top part of the vessel 101, but may be the lateral part or bottom part. Alternatively, a plurality of the second cooling parts 108 may be also provided at the positions including the foregoing in combination with one another.

In order to suppress thermal conduction, the contact area of the second cooling part 108 with the vessel 101 is preferably small, and specifically, the contact area is preferably no less than 100 μm² and no greater than 5 mm².

The vessel 101 is provided with a supply port 109 of a dopant. In FIG. 1, the supply port 109 is provided so as to be in communication with the injection port 102. It is preferred that the supply port 109 be provided at a position enabling the dopant to be rapidly mixed with the sample gas, or a position enabling the dopant to be uniformly mixed with the sample gas.

In the present disclosure, the size and material of the supply port 109 are not limited, but the supply port 109 preferably has a shape that enables the dopant to be uniformly injected into the sample gas. The supply port 109 may also have a large number of through-holes like an air shower device. The shape of the supply port 109 may be of a straight tube as shown in FIG. 1, or may be provided with a branched portion along the path. Also, the supply port 109 may be provided either at one site, or at multiple sites, each of which is in communication with the injection port 102.

A valve 110 is provided at the supply port 109. The valve 110 is used for regulating the amount of injection, injection speed and the like of the dopant. The valve 110 may be a gate valve, a ball valve, a chuck valve, a stop valve, a diaphragm valve, a needle valve, or the like.

A mixer 111 is provided at the supply port 109. The mixer 111 is used for mixing the dopant with the sample gas. The mixer 111 may be a static mixer such as a stator tube mixer, a spiral mixer or a diffuser, or may be an active mixer such as a rotary mixer or a high-frequency mixer.

In the present disclosure, the material, the position and the type of valves 112a and 112b are not limited, but it is preferred that the injection port 102 and the outlet port 103 are provided with the valve 112a and the valve 112b, respectively. It is preferable to render the vessel 101 closable by the valves 112a and 112b. When the conductance of the injection port 102 and the outlet port 103 is small, an effect almost similar to the state in which the vessel 101 is closed can be achieved. Therefore, the valves 112a and 112b may not be used in such a case.

The valve 112a and the valve 112b may be valves for regulating the sample gas flow. The valve 112a and the valve 112b may be a non-return valve, or may be a stop valve.

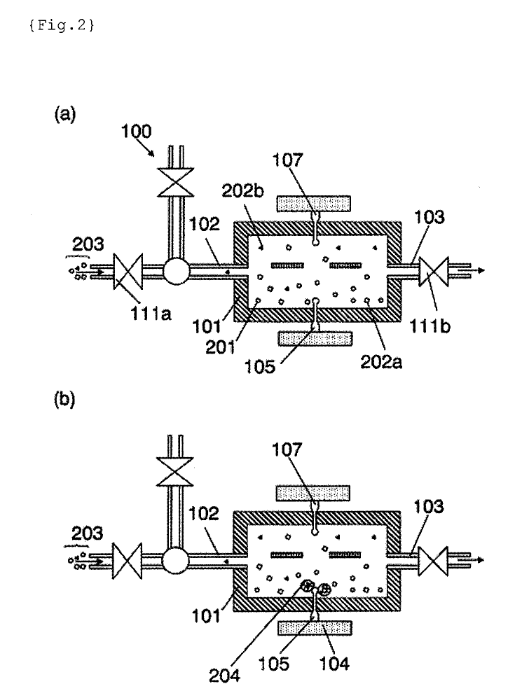

FIG. 2 to FIG. 5 show an explanatory view illustrating the operation of the electrostatic spraying device according to Embodiment 1 of the present disclosure. In FIG. 2 to FIG. 5, the same reference signs are used for the same elements shown in FIG. 1, and their explanation is omitted.

Injection Step

In the injection step, a sample gas 203 containing water vapor 201 and a chemical substance 202 is injected into the vessel 101 through the injection port 103. FIG. 2 (a) shows the injection step. In FIG. 2 (a), only two kinds of the chemical substances 202, i.e., chemical substances 202a and 202b are presented, but the substance may be of one kind, or may be three or more kinds. The relative humidity of the sample gas 203 is preferably no less than 50% and no greater than 100%, and more preferably no less than 80% and no greater than 100%. In the injection step, the water vapor 201 may be newly added to the sample gas 203. In the present disclosure, the type and the concentration of the chemical substance 202 are not limited, and the sample gas 203 preferably contains a polar organic solvent such as acetonitrile, isopropanol, formic acid, or acetic acid.

The sample gas 203 may strike onto the inner wall of the vessel 101, the counter electrode section 106 or the chemical substance recovery unit 107.

It is preferred that the sample gas 203 is injected into the vessel 101 at a large flow rate. The injection speed of the sample gas 203 is preferably no less than 10 sccm and no greater than 1000 sccm, and more preferably no less than 100 sccm and no greater than 500 sccm. The injection speed of the sample gas 203 is preferably constant, but the injection speed may vary. The “sccm” referred to herein means “standard cc/min”.

The sample gas 203 in an amount of no less than 10 mL and no greater than 3000 mL is preferably injected into the vessel 101, and it is more preferred to inject the sample gas 203 in an amount of no less than 100 mL and no greater than 1000 mL.

The sample gas 203 at a room temperature may be injected into the vessel 101, or a warmed sample gas 203 may be injected. The temperature of the sample gas 203 is preferably no less than 20° C. and no greater than 100° C., and more preferably no less than 25° C. and no greater than 40° C.

The sample gas 203 may be injected by compressing the injection port 102 side, or by reducing the pressure of the outlet port 103 side.

Although it is preferred to open the valve 112a and the valve 112b, the flow rate of the sample gas 203 may be regulated by opening or closing the valve 112a and the valve 112b appropriately.

Before the sample gas 203 is injected into the vessel 101, the interior of the vessel 101 is preferably filled with clean air, dry nitrogen, an inert gas, a standard gas having an approximately the same level of relative humidity to that of the sample gas 203, or a gas for calibration.

Excess sample gas 203 is preferably discharged from the outlet port 103.

The pressure inside the vessel 101 is most preferably an ambient pressure, but the pressure of the vessel 101 may be reduced, or compression may be carried out. In the present disclosure, the pressure inside the vessel 101 is not limited.

In the steps following the injection step, the temperatures of the vessel 101, the injection port 102, the outlet port 103, and the counter electrode section 106 are preferably kept at no lower than the dew-point temperature of the water vapor so as to prevent the dew formation of the sample gas 203.

First Condensate Liquid Formation Step

Next, in the first condensate liquid formation step, the atomizing electrode section 105 is cooled by the cooling part 104 to no higher than the dew-point temperature of the water vapor 201. On the outer peripheral surface of the atomizing electrode section 105, a first condensate liquid 204 containing the water vapor 201 and the chemical substance 202 is formed. FIG. 2 (b) shows the first condensate liquid formation step. In the initial stage of the first condensate liquid formation step, the first condensate liquid 204 forms droplets on the outer peripheral surface of the atomizing electrode section 105. In the stage of progress of the first condensate liquid formation step, the outer peripheral surface of the atomizing electrode section 105 is covered by the first condensate liquid 204.

It is preferred to regulate the temperature of the cooling part 104 so as not to increase the amount of the first condensate liquid 204 excessively. The temperature of the atomizing electrode section 105 is preferably no lower than the solidifying point of the first condensate liquid 204.

The temperature of the atomizing electrode section 105 is preferably no less than 0° C. and no greater than 20° C., and more preferably no less than 0° C. and no greater than 15° C.

It is preferred that the sample gas 203 be injected continuously, but the injection of the sample gas 203 may be stopped.

Supplying Step

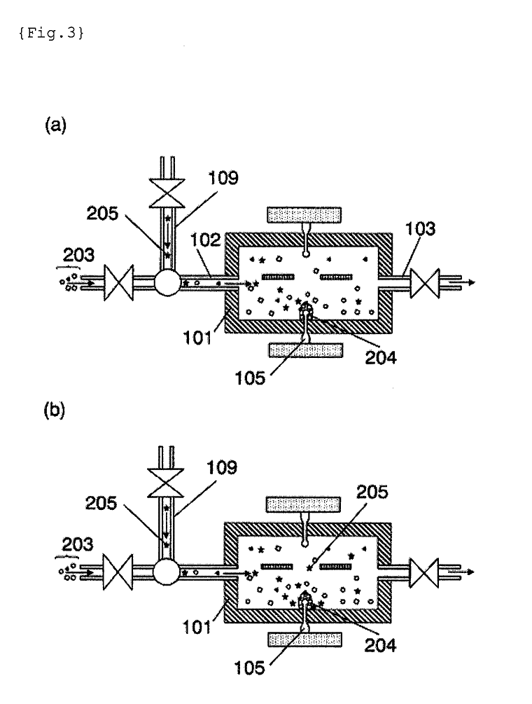

In the supplying step, a dopant 205 is supplied into the vessel 101. FIG. 3 (a) shows the supplying step. The dopant 205 is supplied into the vessel 101 through the supply port 109. The dopant 205 is supplied into the vessel 101 through the injection port 102.

The dopant 205 is a substance that is dissolved into the first condensate liquid 204. The electronic affinity of the dopant 205 is greater than the electronic affinity of water.

The dopant 205 is preferably an organic compound, and is more preferably a polar organic compound, a water soluble organic compound or an organic compound that is a biomolecule.

The dopant 205 is preferably an organic acid. Although the dopant 205 is more preferably acetic acid, it may be formic acid, citric acid, oxalic acid or the like.

The dopant 205 is preferably a lower alcohol, but may be a higher alcohol. Although the lower alcohol is most preferably ethanol, it may be methanol, 2-propanol, butanol or the like.

The dopant 205 may be an aliphatic hydrocarbon, and may be an aromatic hydrocarbon. As the dopant 205, acetone, acetaldehyde, chloroform, carbon tetrachloride, butadiene, tetracyanoethylene, formaldehyde, azulene, acetophenone, anisole, aniline, 9,10-anthraquinone, o-xylene, chlorobenzene, 1,2,3,5-tetramethylbenzene, triphenylene, toluene, naphthalene, biphenyl, pyrene, phenol, fluorobenzene, hexamethylbenzene, benzene, benzoquinone, pentacene, phthalic anhydride or the like can be used.

The dopant 205 may be aromatic molecule of esters, ketones, sesquiterpenes, terpenes, aromatic aldehydes, monoterpenes, lactones or the like. The dopant 205 is preferably methyl salicylate, menthol or sclareol, and linalyl acetate, limonene, linalool or the like can be also used.

The dopant 205 may also be a volatile organic compound, and the molecular weight is preferably no less than 16 and no greater than 300.

The dopant 205 may also be oxygen, nitrogen dioxide, nitrogen monooxide or carbon dioxide.

The concentration of the dopant 205 in the sample gas 203 is preferably no greater than 0.03% and no greater than 3%, and more preferably no less than 0.3% and no greater than 1%.

The temperature of the dopant 205 is preferably no less than 20° C. and no greater than 100° C., and more preferably no less than 25° C. and no greater than 40° C. The temperature of the dopant 205 is most preferably the same temperature of the sample gas 203, but may be lower or higher the temperature of the sample gas 203.

The supplying speed of the dopant 205 is preferably no less than 0.01 sccm and no greater than 1000 sccm, and more preferably no less than 0.1 sccm and no greater than 5 sccm. The injection speed of the dopant 205 is preferably constant, but the injection speed may vary.

Dopant Cooling Step

In the dopant cooling step, the dopant 205 is cooled on the outer peripheral surface of the atomizing electrode section 105. FIG. 3 (b) shows the dopant cooling step. The dopant 205 is preferably cooled by the atomizing electrode section 105, but may be cooled by a condenser. The temperature of the dopant 205 is preferably no less than 0° C. and no greater than 20° C., and more preferably no less than 0° C. and no greater than 15° C. The dopant 205 is preferably cooled concomitantly with the sample gas 203.

Dissolving Step

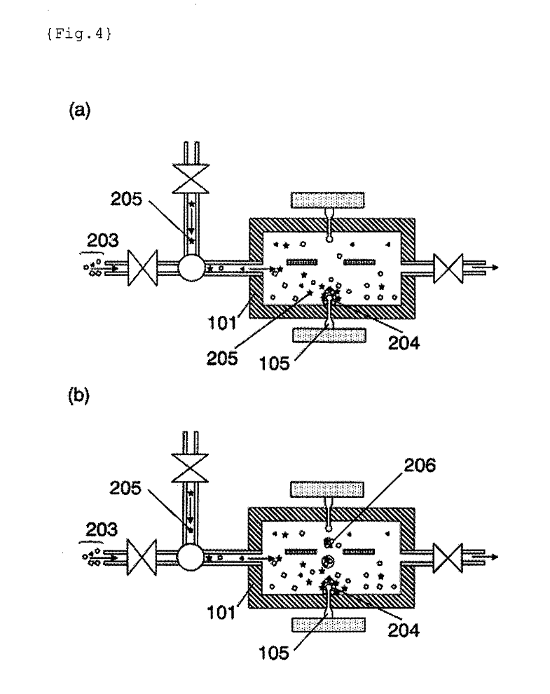

In the dissolving step, the dopant 205 is dissolved into the first condensate liquid 204. FIG. 4 (a) shows the dissolving step. It is preferred that the cooled dopant 205 be dissolved into the first condensate liquid 204. The dopant 205 is preferably water soluble. The concentration of the dopant 205 in the first condensate liquid 204 is preferably higher than the concentration of the chemical substance 202 in the first condensate liquid 204. The concentration of the dopant 205 in the first condensate liquid 204 is preferably no less than 0.1 ppm and no greater than 3%.

In the dissolving step, it is preferred that the dopant 205 is uniformly dissolved in the first condensate liquid 204, but the dopant 205 may be mixed with the first condensate liquid 204. It is preferred that first condensate liquid 204 migrates on the outer peripheral surface of the atomizing electrode section 105. The surface area of the first condensate liquid 204 is preferably large so that the dopant 205 can be readily dissolved in the first condensate liquid 204. The first condensate liquid 204 is preferably in a droplet state or an aqueous film state.

Charged Fine Particle Production Step

Next, in the charged fine particle production step, a large number of first charged fine particles 206 are formed from the first condensate liquid 204. FIG. 4 (b) shows the charged fine particle production step. The first charged fine particles 206 may be: a cluster including one to several ten molecules; fine particles including several ten to several hundred molecules; or may be a droplet including several hundred or more molecules. Alternatively, two or more types of these may be present admixed.

The first charged fine particles 206 may also include electrically neutral molecules, or ions or radicals derived from the sample gas 203.

It is preferred that the first charged fine particle 206 be negatively charged. When the first charged fine particles 206 are negatively charged, the electronic affinity of the chemical substance 202 is preferably greater than the electronic affinity of water. Moreover, the electronic affinity of the dopant 205 is preferably greater than the electronic affinity of water and the chemical substance 202.

It is preferred that the first charged fine particle 206 be positively charged. When the first charged fine particles 206 are positively charged, the ionization energy of the chemical substance 202 is preferably smaller than the ionization energy of water. Moreover, the ionization energy of the dopant 205 is preferably smaller than the ionization energy of water and the chemical substance 202.

The method for forming charged fine particles from the first condensate liquid 204 is most preferably electrostatic spraying. The principle of the electrostatic spraying is as follows. The first condensate liquid 204 is conveyed to the tip of the atomizing electrode section 105 by the voltage applied between the atomizing electrode section 105 and the counter electrode section 106. The liquid level of the first condensate liquid 204 is elevated by the coulomb attractive force to form a conical shape toward the counter electrode section 106 direction. When the condensation further proceeds on the outer peripheral surface of the atomizing electrode section 105, the first condensate liquid 204 having a conical shape grows. Thereafter, the charge concentrates to the tip of the first condensate liquid 204, thereby leading to increase in the coulomb force. When this coulomb force exceeds the surface tension of water, the first condensate liquid 204 is disrupted and scatters to form the first charged fine particles 206.

In light of the stability of the first charged fine particle 206, the first charged fine particle 206 has a diameter of preferably no less than 1 nm and no greater than 30 nm.

The charge amount added to the first charged fine particle 206 is preferably no less than the same level and no greater than ten times of the elementary electric charge (1.6×10⁻¹⁹ C) per the fine particle.

The proportion of the chemical substance 202 with respect to the water vapor 201 in the first charged fine particle 206 is preferably higher than the proportion of the chemical substance 202 with respect to the water vapor 201 in the sample gas 203. The proportion of the chemical substance 202 with respect to the water vapor 201 in the first charged fine particles 206 may vary until reaching the chemical substance recovery unit 107, and preferably increases until reaching the chemical substance recovery unit 107.

It is most preferred that a direct current voltage be applied between the atomizing electrode section 105 and the counter electrode section 106. In other words, to provide an electric potential difference between the atomizing electrode section 105 and the counter electrode section 106 is most preferred. A voltage not causing corona discharge is preferably applied between the atomizing electrode section 105 and the counter electrode section 106, and specifically, a direct current voltage of no less than 4 kV and no greater than 6 kV is preferably applied.

In the charged fine particle production step, it is most preferred to apply a negative voltage to the atomizing electrode section 105 with respect to the counter electrode section 106, but a positive voltage may be applied. The counter electrode section 106 is most preferably a GND electrode. In the charged fine particle production step, an alternating current voltage may be applied between the atomizing electrode section 105 and the counter electrode section 106. Also, a pulse voltage may be applied between the atomizing electrode section 105 and the counter electrode section 106.

The value of the direct current voltage applied between the atomizing electrode section 105 and the counter electrode section 106 may be constant, or varying. The varying value is preferably regulated depending on the state of forming the charged fine particles. With respect to the state of forming charged fine particles, the electric current value running between the atomizing electrode section 105 and the counter electrode section 106 may be monitored, or the electric current value may be monitored with a dedicated electrode pair provided for monitoring purposes.

Recovery Step

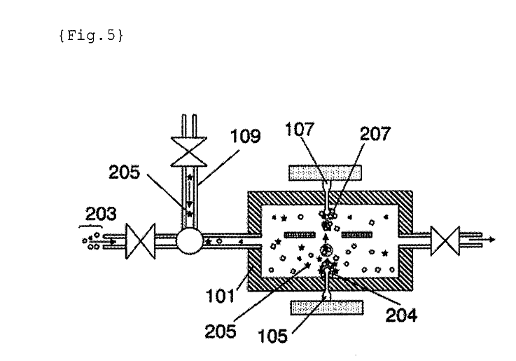

In the recovery step, the first charged fine particles 206 are recovered into the chemical substance recovery unit 107. FIG. 5 shows the recovery step. In the recovery step, the sample gas 203 may be recovered directly into the chemical substance recovery unit 107. The amount of the sample gas 203 directly recovered into the chemical substance recovery unit 107 is preferably as small as possible. Also, the injection step is preferably stopped during the recovery step.

The first charged fine particles 206 are preferably recovered by an electromagnetic force or electrostatic force. In the recovery step, a direct current voltage is preferably applied to the chemical substance recovery unit 107 with respect to the counter electrode section 106. In other words, an electric potential difference is preferably provided between the counter electrode section 106 and the chemical substance recovery unit 107. The direct current voltage is preferably no less than 0.01 kV and no greater than 6 kV, and more preferably no less than 0.01 kV and no greater than 0.6 kV.

When the first charged fine particles 206 are negatively charged, a positive voltage is preferably applied to the chemical substance recovery unit 107 with respect to the counter electrode section 106. To the contrary, when the first charged fine particles 206 are positively charged, a negative voltage is preferably applied to the chemical substance recovery unit 107 with respect to the counter electrode section 106. The voltage is preferably applied continuously, but may be applied in a pulsating manner.

The counter electrode section 106 is most preferably a GND electrode. An alternating current voltage is preferably applied between the chemical substance recovery unit 107 and the counter electrode section 106, but a pulse voltage may be applied.

The chemical substance recovery unit 107 is preferably cooled to no higher than the dew-point temperature of the water vapor 201. It is preferred that the first charged fine particle 206 be used as a recovered liquid 207 on the outer peripheral surface of the chemical substance recovery unit 107. In the initial stage of the recovery step, the recovered liquid 207 preferably forms droplets on the outer peripheral surface of the chemical substance recovery unit 107. In the stage of progress of the recovery step, the outer peripheral surface of the chemical substance recovery unit 107 is preferably covered by the recovered liquid 207. The chemical substance recovery unit 107 preferably has a needle-like shape, and the recovered liquid 207 is preferably recovered at the tip of the chemical substance recovery unit 107. The outer peripheral surface of the chemical substance recovery unit 107 is preferably hydrophilic, but may be water-repellent.

The chemical substance recovery unit 107 is preferably oriented downward. As shown in FIG. 5, the recovered liquid 207 is preferably recovered at the tip of the chemical substance recovery unit 107 by the gravity.

As shown in FIG. 5, it is also preferred that the recovered liquid 207 be recovered at the tip of the chemical substance recovery unit 107 by an electrostatic force. The tip of the chemical substance recovery unit 107 preferably has a shape suited for concentration of the electric field, and most preferably has a needle-like shape. The recovered liquid 207 preferably migrates to the tip of the chemical substance recovery unit 107 by the electrostatic force on the outer peripheral surface of the chemical substance recovery unit 107. The recovered liquid 207 preferably contains a polar organic compound or water.

It is preferred that the chemical substance recovery unit 107 be electrically neutralized. The electrical neutralization of the chemical substance recovery unit 107 may be carried out either constantly or in an appropriate manner. The electrical neutralization of the chemical substance recovery unit 107 may be carried out by grounding, or using an ionizer.

After the voltage is applied to the chemical substance recovery unit 107 with respect to the counter electrode section 106, it is most preferred that the chemical substance recovery unit 107 be cooled. Concurrently with the application of the voltage to the chemical substance recovery unit 107 with respect to the counter electrode section 106, the chemical substance recovery unit 107 may be cooled. In addition, the sample gas 203 may be directly condensed at the chemical substance recovery unit 107.

Interfering substances other than the water vapor 201 and the subject substance of detection included in the recovered liquid 207 may be eliminated. In order to eliminate the interfering substance from the recovered liquid 207, a filter or an adsorbent may be used. Alternatively, other elimination methods may be also employed.

In the present Embodiment, at least two steps of the aforementioned injection step to the recovery step may be concurrently carried out. More specifically, for example, the injection step and the first condensate liquid formation step may be carried out concurrently. Alternatively, each of these steps may be carried out in an orderly sequence.

### Embodiment 2

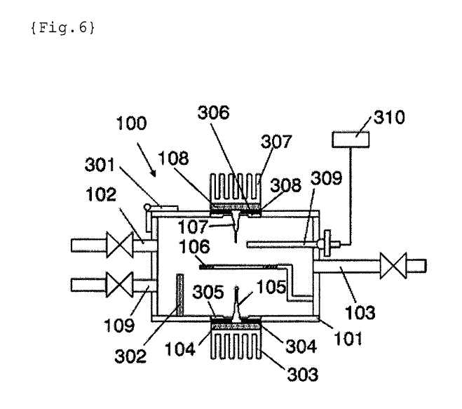

FIG. 6 shows an exemplary schematic diagram illustrating an electrostatic spraying device according to Embodiment 2 of the present disclosure. In FIG. 6, the same reference numerals are given to the identical elements to those in FIG. 1, and their explanation is omitted.

The most prominent difference between the present Embodiment and Embodiment 1 lies in the addition of a function of mixer 111 to the vessel 101 itself. More specifically, the sample gas 203 and the dopant 205 are mixed in the vessel 101. For this purpose, the supply port 109 is directly connected to the vessel 101. In the vessel 101, the sample gas 203 and the dopant 205 are mixed.

In the present Embodiment, the electrostatic spraying device 100 has the following construction.

Although the vessel 101 is preferably hard, it may be soft as in the case of an air bag, balloon, flexible tube, syringe or the like. In light of the maintenance, the vessel 101 is preferably openable and closable by a hinge 301, or any other method to enable opening and closing is also acceptable.

A barrier 302 is preferably provided in the vicinity of the supply port 109 in the vessel 101 such that the sample gas generates a turbent flow, spiral flow, vortex flow and the like. In the vessel 101, a maze may be provided such that the sample gas generates a turbent flow, spiral flow, vortex flow and the like.

The injection port 102 is provided so as to be in communication with the vessel 101. The injection port 102 is used for injecting the sample gas into the vessel 101. It is preferred that the injection port 102 be provided at a position enabling the sample gas to be rapidly injected into the vessel 101, and/or a position enabling the sample gas to be injected uniformly into the vessel 101. An injection port 102 is preferably provided at a position that enables the sample gas to generate a turbent flow, spiral flow, vortex flow and the like. For example, when the vessel 101 is a rectangular solid, the injection port 102 is preferably provided in the corner.

Although the size and the material of the injection port 102 are not limited in the present disclosure, it preferably has a shape that enables the sample gas to be uniformly injected into the vessel 101. The injection port 102 may also have a large number of through-holes like an air shower device. The tip of the injection port 102 may be inclined in a direction based on the wall of the vessel 101 such that the sample gas generates a spiral flow in the vessel 101. Alternatively, the tip of the injection port 102 may be tapered to utilize a venturi effect such that the sample gas generates a spiral flow. The shape of the injection port 102 may be of a straight tube as shown in FIG. 6, or may be provided with a branched portion along the path. The injection port 102 may be provided either at one site, or at multiple sites.

The outlet port 103 is provided at the other end of the vessel 101. The outlet port 103 is used for discharging the excess sample gas from the sample gas filled in the vessel 101. The outlet port 103 is preferably provided at a position enabling the sample gas filled in the vessel 101 to be rapidly discharged. The outlet port 103 may be provided at a position where the sample gas generates a turbent flow, spiral flow, vortex flow or the like. As shown in FIG. 6, the injection port 102 and the outlet port 103 may be provided at different heights. The injection port 103 and the outlet port 104 are preferably provided at opposing corners of the vessel 101.

In the present disclosure, the shape, the size and the material of the outlet port 103 are not limited. The shape of the outlet port 103 may be of a straight tube as shown in FIG. 6, or may be provided with a branched portion along the path. The outlet port 103 may be provided either at one site, or at multiple sites.

The cooling part 104 is preferably provided with a heat radiation part 303. When a thermoelectric element is used as the cooling part 104, the back of the cooling face is a heat generation face. The heat radiation part 303 is used for releasing the heat from the heat generation face. By releasing the heat from the heat generation face, the thermoelectric element can be efficiently operated. The heat radiation part 303 is preferably a fin, and more preferably the fin is attached to a cooling fan. Alternatively, the heat radiation part 303 may be a water cooling mechanism. The heat radiation part 303 is preferably formed from a material having a thermal conductivity. The material of the heat radiation part 303 may be a metal, semiconductor, or the like.

The cooling part 104 is preferably provided with a thermal protection part 304. By providing the thermal protection part 304, sites other than the atomizing electrode section 105 are not cooled. The material of the thermal protection part 304 preferably has a low thermal conductivity. The material of the thermal protection part 304 is preferably a rubber, ceramic, glass or the like, but an air gap is also acceptable. The content in the air gap is preferably air, nitrogen or the like. The thermal protection part 304 is preferably a nonconductor.

In light of suppression of thermal conduction, the contact area of the atomizing electrode section 105 with the thermal protection part 304 is preferably small, and specifically, no less than 10 μm² and no greater than 10 mm².

The atomizing electrode section 105 is preferably provided with an insulating part 305. The insulating part 305 serves to electrically insulate the vessel 101 from the atomizing electrode section 105. The material of the insulating part 305 is preferably an insulator such as Teflon (registered trademark), Delrin (registered trademark), PEEK (registered trademark) or the like. In order to retain an excess condensate liquid, the insulating part 305 is preferably provided with a reservoir part. The reservoir part preferably has a groove structure, relief structure, an absorbent core or the like. In the present disclosure, the shape, the material and the position of the insulating part 305 are not limited.

In light of suppression of the thermal conduction, the contact area of the atomizing electrode section 105 with the insulating part 305 is preferably small, and specifically, no less than 10 μm² and no greater than 10 mm². In order to suppress dew condensation of the water vapor, it is preferred to use a material having a less thermal conductivity for the insulating part 305, and a structure for suppressing thermal conduction is preferably provided.

The counter electrode section 106 is preferably provided at a position where the sample gas 203 is mixed with the dopant 205. It is preferred that the counter electrode section 106 is present in the vicinity of the injection port 102 and the supply port 109.

The chemical substance recovery unit 107 is preferably provided at a position that leads to suppression of direct condensation of the sample gas 203 with the dopant 205. The distance between the injection port 102 and the chemical substance recovery unit 107 is preferably greater than the distance between the injection port 102 and the atomizing electrode section 105. The distance between the supply port 109 and the chemical substance recovery unit 107 is preferably greater than the distance between the supply port 109 and the atomizing electrode section 105.

The chemical substance recovery unit 107 is preferably provided with a second insulating part 306. The second insulating part 306 serves to electrically insulate the vessel 101 from the chemical substance recovery unit 107. The material of the second insulating part 306 is preferably an insulator such as Teflon (registered trademark), Delrin (registered trademark), PEEK (registered trademark) or the like. In order to retain an excess condensate liquid, the second insulating part 306 is preferably provided with a reservoir part. The reservoir part preferably has a groove structure, relief structure, an absorbent core or the like. In the present disclosure, the shape, the material and the position of the second insulating part 306 are not limited.

In light of suppression of the thermal conduction, the contact area of the chemical substance recovery unit 107 with the second insulating part 306 is preferably small, and specifically, no less than 10 μm² and no greater than 10 mm².

The second cooling part 108 is preferably provided with a second heat radiation part 307. When a thermoelectric element is used as the second cooling part 108, the back of the cooling face is a heat generation face. The second heat radiation part 307 is used for releasing the heat from the heat generation face. By releasing the heat from the heat generation face, the thermoelectric element can be efficiently operated. The second heat radiation part 307 is preferably a fin, and more preferably the fin is attached to a cooling fan. Alternatively, the second heat radiation part 307 may be a water cooling mechanism. The second heat radiation part 307 is preferably formed from a material having a thermal conductivity. The material of the second heat radiation part 307 may be preferably a metal, semiconductor, or the like.

The second cooling part 108 is preferably provided with a second thermal protection part 308. By providing the second thermal protection part 308, cooling of sites other than the chemical substance recovery unit 107 can be avoided. The second thermal protection part 308 is preferably formed with a material having a low thermal conductivity such as a rubber, ceramic, glass or the like. The second thermal protection part 308 may also be an air gap. The content in the air gap is preferably air, nitrogen or the like.

In light of suppression of the thermal conduction, the contact area of the chemical substance recovery unit 107 with a second thermal protection part 308 is preferably small, and specifically, no less than 10 μm² and no greater than 10 mm².

A chemical substance convey part 309 and a chemical substance detection unit 310 are preferably provided in the vicinity of the chemical substance recovery unit 107. The chemical substance convey part 309 is used for conveying the chemical substance recovered in the chemical substance recovery unit 107 to the chemical substance detection unit 310. The chemical substance convey part 309 may be a syringe, capillary, tube, porous material, and a pump may be also provided. Since a high voltage is applied to the chemical substance recovery unit 107, it is preferred to electrically insulate the chemical substance convey part 309 from the chemical substance recovery unit 107.

The chemical substance convey part 309 is preferably movable, and is preferably movable in at least one direction of X-direction, Y-direction, and Z-direction. The X-direction referred to herein means the longitudinal direction of the chemical substance convey part 309 in FIG. 6. The Y-direction and the Z-direction are perpendicular to the X-direction, respectively. The chemical substance convey part 309 is preferably movable in the θ-direction. The θ-direction herein referred to means a direction to allow the chemical substance convey part 309 to rotate in the vertical direction, with a site at which the chemical substance convey part 309 is fixed to the vessel 101, as the point of support. Rotation in the horizontal direction with a site at which the chemical substance convey part 309 is fixed to the vessel 101, as the point of support is also acceptable.

The chemical substance convey part 309 may be present inside the vessel 101, at one end of the chemical substance recovery unit 107, or outside of the vessel 101.

The chemical substance detection unit 310 is preferably a chemical sensor, a biosensor or the like, and may be a MOSFET (metal-oxide-semiconductor electric field effect transistor), an ISFET (ion sensitive electric field effect transistor), a bipolar transistor, an organic thin film transistor, an optode, a metal oxide semiconductor sensor, a quartz-crystal microbalance (QCM), a surface elastic wave (SAW) element, a solid electrolyte gas sensor, an electrochemical battery sensor, surface plasmon resonance (SPR), a Langmuir-Blodgett membrane (LB membrane) sensor, AFM, a DNA sensor, a protein sensor, an immune sensor, a microorganism sensor or the like. Alternatively, the chemical substance detection unit 310 may be a gas chromatograph (GC), GC-MS, GC-TOF/MS, a high performance liquid chromatograph (LC), HPLC, HPLC/IC, LC-TOF/MS, MALDI, a nuclear magnetic resonance apparatus (NMR), SIMS, an ICP mass spectrometer or the like. The chemical substance detection unit 310 may be provided at one site as shown in FIG. 6, or at multiple sites. When multiple chemical substance detection units 310 are provided, they may be of a single type, or of different plural types.

The chemical substance detection unit 310 may be present outside of the vessel 101, inside of the vessel 101, or at one end of the chemical substance recovery unit 107.

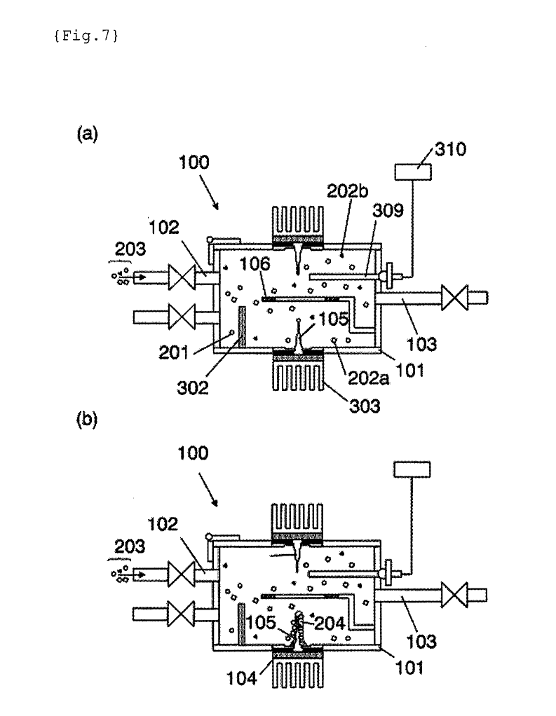

FIG. 7 to FIG. 10 show an explanatory view that illustrates operation of the electrostatic spraying device according to Embodiment 2. In FIG. 7 to FIG. 10, the same reference numerals are given to the identical elements to those in FIG. 6, and their explanation is omitted.

Injection Step

In the injection step, the sample gas 203 containing the water vapor 201 and the chemical substance 202 is injected into the vessel 101 through the injection port 102. FIG. 7 (a) shows the injection step. In FIG. 7 (a), only two kinds of the chemical substance 202, i.e., chemical substances 202a and 202b are presented, but the substance may be of one kind, or may be three or more kinds. The relative humidity in the sample gas 203 is preferably no less than 50%, and more preferably no less than 80%. In the injection step, the water vapor 201 may be added to the sample gas 203. In the present disclosure, the type and the concentration of the chemical substance 202 are not limited. The sample gas 203 preferably contains a polar organic solvent. In the present disclosure, the type and the concentration of the polar organic solvent are not limited.

The sample gas 203 may strike onto the inner wall of the vessel 101, the counter electrode section 106 or the chemical substance recovery unit 107. Alternatively, the sample gas 203 may strike onto the barrier 302, the maze provided inside the vessel 101.

In order to determine filling the vessel 101 with the sample gas 203, the chemical substance detection unit 310 may be used, or a chemical substance detection unit other than the chemical substance detection unit 310 may be also used. Alternatively, the number of the chemical substance detection units 310 may be either one, or two or more.

First Condensate Liquid Formation Step

Next, in the first condensate liquid formation step, the atomizing electrode section 105 is cooled by the cooling part 104 to no higher than the dew-point temperature of the water vapor 201. On the outer peripheral surface of the atomizing electrode section 105, first condensate liquid 204 containing the water vapor 201 and the chemical substance 202 is formed. FIG. 7 (b) shows the first condensate liquid formation step.

Supplying Step

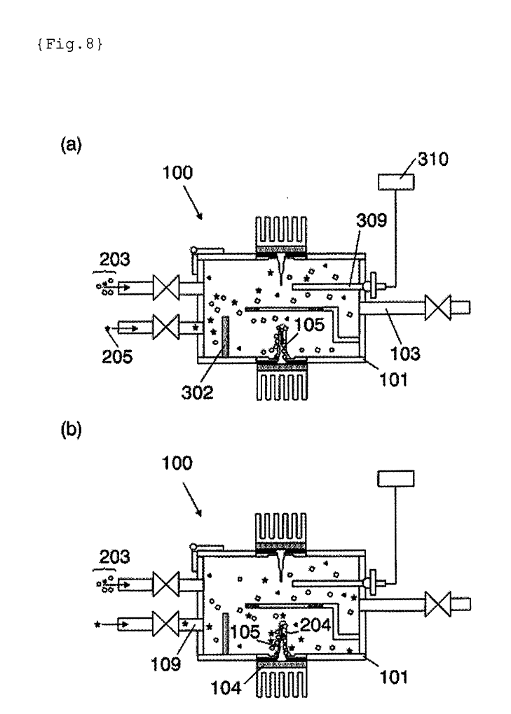

In the supplying step, dopant 205 is supplied into the vessel 101. FIG. 8 (a) shows the supplying step. The dopant 205 is supplied into the vessel 101 through the supply port 109. The dopant 205 preferably strikes onto the barrier 302.

Dopant Cooling Step

In the dopant cooling step, the dopant 205 is cooled on the outer peripheral surface of the atomizing electrode section 105. FIG. 8 (b) shows the dopant cooling step.

Dissolving Step

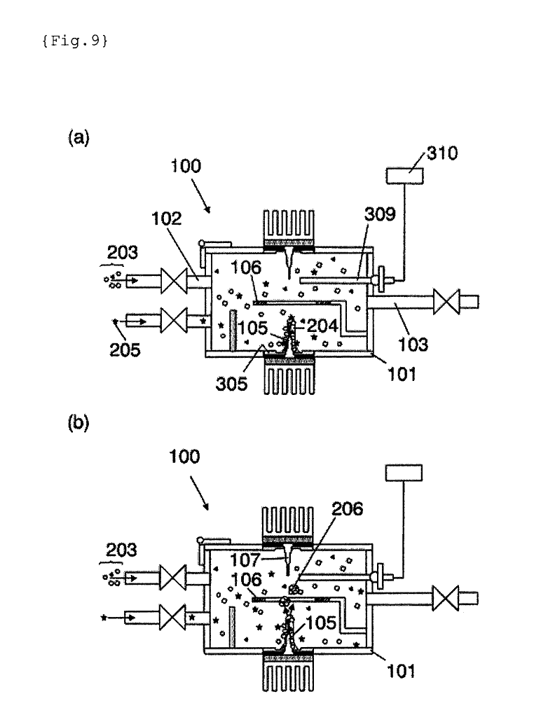

In the dissolving step, the dopant 205 is dissolved into the first condensate liquid 204. FIG. 9 (a) shows the dissolving step.

First Charged Fine Particle Production Step

Next, in the first charged fine particle production step, a large number of first charged fine particles 206 are formed from the first condensate liquid 204. FIG. 9 (b) shows the first charged fine particle production step. The first charged fine particles 206 may be: a cluster including one to several ten molecules; fine particles including several ten to several hundred molecules; or may be a droplet including several hundred or more molecules. Alternatively, two or more types of these may be present admixed.

In the first charged fine particle production step, the first charged fine particles 206 may also include electrically neutral molecules, or ions or radicals derived from the sample gas 203.

In the first charged fine particle production step, it is preferred that the first charged fine particle 206 be negatively charged. When the first charged fine particles 206 are negatively charged, the electronic affinity of the chemical substance 202 is preferably greater than the electronic affinity of water. When the first charged fine particles 206 are negatively charged, the electronic affinity of the dopant 205 is preferably greater than the electronic affinity of water and the chemical substance 202.

In the first charged fine particle production step, it is preferred that the first charged fine particle 206 be positively charged. When the first charged fine particles 206 are positively charged, the ionization energy of the chemical substance 202 is preferably smaller than the ionization energy of water. When the first charged fine particles 206 are positively charged, the ionization energy of the dopant 205 is preferably smaller than the ionization energy of water and the chemical substance 202.

The method for forming charged fine particles from the first condensate liquid 204 is most preferably electrostatic spraying. The principle of the electrostatic spraying is as follows. The first condensate liquid 204 is conveyed to the tip of the atomizing electrode section 105 by the voltage applied between the atomizing electrode section 105 and the counter electrode section 106. The liquid level of the first condensate liquid 204 is elevated by the coulomb attractive force to form a conical shape toward the counter electrode section 106 direction. When the condensation further proceeds on the outer peripheral surface of the atomizing electrode section 105, the first condensate liquid 204 having a conical shape grows. Thereafter, the charge concentrates to the tip of the first condensate liquid 204, thereby leading to an increase in the coulomb force. When this coulomb force exceeds the surface tension of water, the first condensate liquid 204 is disrupted and scatters to form the first charged fine particles 206.

In the first charged fine particle production step, it is most preferred that a direct current voltage be applied between the atomizing electrode section 105 and the counter electrode section 106. A voltage not causing corona discharge is preferably applied, and specifically, the direct current voltage is preferably no less than 4 kV and no greater than 6 kV. It is most preferred to apply a negative voltage to the atomizing electrode section 105 with respect to the counter electrode section 106, but a positive voltage may be applied. The counter electrode section 106 is most preferably a GND electrode.

An alternating current voltage may be applied between the atomizing electrode section 105 and the counter electrode section 106, or a pulse voltage may be applied.

Second Charged Fine Particle Production Step

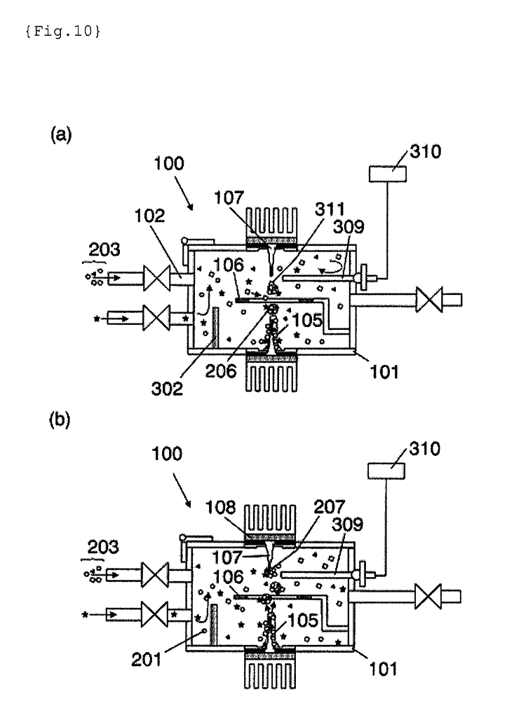

Next, in the second charged fine particle production step, the first charged fine particles 206 and the sample gas 203 may be mixed in the vessel 101 to produce second charged fine particles 311. FIG. 10 (a) shows the second charged fine particle production step. By mixing the first charged fine particles 206 with the sample gas 203, the sample gas 203 can be charged. For efficiently mixing the first charged fine particles 206 with the sample gas 203, the sample gas 203 preferably generates a turbent flow, a spiral flow, a vortex flow or the like. The direction of the flow of the first charged fine particles 206 may be perpendicular to the direction of the flow of the sample gas 203, or a counter flow may be provided. The vessel 101 preferably has a cross flow path, or a T-shaped flow path. The second charged fine particles 311 may be mixed with the sample gas 203 to produce third charged fine particles.

Second Charged Fine Particle Production Step

In the second charged fine particle production step, almost all of the first charged fine particles 206 transfer from the atomizing electrode section 105 to the chemical substance recovery unit 107 via the counter electrode section 106. Therefore, it is preferred to provide the injection port 102 at a position that enables the sample gas 203 to be injected toward the area between the atomizing electrode section 105 and the chemical substance recovery unit 107. Although it is preferred to provide the injection port 102 at a position that enables the sample gas 203 to be injected toward the area between the atomizing electrode section 105 and the counter electrode section 106, the injection port 102 may be provided at a position that enables the sample gas 203 to be injected toward the area between the counter electrode section 106 and the chemical substance recovery unit 107. The sample gas 203 may be focused onto the path of the first charged fine particles 206.

The diameter of the second charged fine particle 311 is preferably greater than the diameter of the first charged fine particle 206. In light of stability of the second charged fine particles 311, the second charged fine particles 311 preferably have a diameter of no less than 1 nm and no greater than 30 nm. The second charged fine particles 311 may be: a cluster including one to several ten molecules; fine particles including several ten to several hundred molecules; or may be a droplet including several hundred or more molecules. Alternatively, two or more types of these may be present admixed.

The second charged fine particles 311 may also include electrically neutral molecules, ions radicals or the like. In the second charged fine particle production step, the charges of the first charged fine particles 206 and the second charged fine particles 311 are preferably the same, but the second charged fine particles 311 may be either negatively charged, or positively charged.

The charge amount of the second charged fine particle 311 is preferably the same as the charge amount of the first charged fine particle 206. The charge amount of the second charged fine particle 311 is preferably no less than the same level and no greater than ten times the elementary electric charge (1.6×10⁻¹⁹ C) per the fine particle.

Recovery Step

Finally, in the recovery step, the first charged fine particles 206 and the second charged fine particles 311 are recovered into the chemical substance recovery unit 107. FIG. 10 (b) shows the recovery step. In the recovery step, it is preferred that the first charged fine particles 206 and the second charged fine particles 311 be concomitantly recovered into the chemical substance recovery unit 107. In the present disclosure, the proportion of the first charged fine particles 206 to the second charged fine particles 311 recovered into the chemical substance recovery unit 107 is not limited. In the recovery step, the sample gas 203 may be directly recovered into the chemical substance recovery unit 107. The amount of the sample gas 203 directly recovered into the chemical substance recovery unit 107 is preferably as small as possible. The injection step is preferably stopped during the recovery step.

In the recovery step, the first charged fine particles 206 and the second charged fine particles 311 are preferably recovered by an electromagnetic force, but may be recovered by an electrostatic force. A direct current voltage is preferably applied to the chemical substance recovery unit 107 with respect to the counter electrode section 106. The direct current voltage is preferably no less than 0.01 kV and no greater than 6 kV, and more preferably no less than 0.01 kV and no greater than 0.5 kV.

When the first charged fine particles 206 and the second charged fine particles 311 are negatively charged, application of a positive voltage to the chemical substance recovery unit 107 with respect to the counter electrode section 106 is most preferred. When the first charged fine particles 206 and the second charged fine particles 311 are positively charged, a negative voltage is preferably applied to the chemical substance recovery unit 107 with respect to the counter electrode section 106. The voltage is preferably applied continuously, but may be applied in a pulsating manner. The counter electrode section 106 is most preferably a GND electrode. An alternating current voltage is preferably applied between the chemical substance recovery unit 107 and the counter electrode section 106, but a pulse voltage may be applied.

The chemical substance recovery unit 107 is preferably cooled to no higher than the dew-point temperature of the water vapor 201. It is preferred that the first charged fine particle 206 and the second charged fine particles 311 be used as the recovered liquid 207 on the outer peripheral surface of the chemical substance recovery unit 107. In the initial stage of the recovery step, the recovered liquid 207 preferably forms droplets on the outer peripheral surface of the chemical substance recovery unit 107. In the next stage of the recovery step, the outer peripheral surface of the chemical substance recovery unit 107 is preferably covered by the recovered liquid 207. The chemical substance recovery unit 107 preferably has a needle-like shape, and the recovered liquid 207 is preferably recovered at the tip of the chemical substance recovery unit 107. The outer peripheral surface of the chemical substance recovery unit 107 is preferably hydrophilic, but may be water-repellent.

The chemical substance recovery unit 107 is preferably cooled by the second cooling part 108. The chemical substance recovery unit 107 can be cooled by the second cooling part 108 to no higher than the dew-point temperature of water vapor. In the recovery step, the temperature of the second cooling part 108 is preferably regulated so as not to increase the amount of the recovered liquid 207 in excess. The temperature of the chemical substance recovery unit 107 may be no less than the freezing point of the recovered liquid 207, or may be no greater than the freezing point of the recovered liquid 207.

The chemical substance recovery unit 107 is preferably oriented downward. As shown in FIG. 6, the recovered liquid 207 is preferably recovered at the tip of the chemical substance recovery unit 107 by the gravity.

As shown in FIG. 10 (b), it is also preferred that the recovered liquid 207 be recovered at the tip of the chemical substance recovery unit 107 by an electrostatic force in the recovery step. The tip of the chemical substance recovery unit 107 preferably has a shape suited for concentration of the electric field. The chemical substance recovery unit 107 most preferably has a needle-like shape. The recovered liquid 207 preferably migrates to the tip of the chemical substance recovery unit 107 by the electrostatic force on the outer peripheral surface of the chemical substance recovery unit 107. The recovered liquid 207 preferably contains a polar organic compound and/or water.

In the recovery step, it is preferred that the recovered liquid 207 be conveyed to the chemical substance detection unit 310 by the chemical substance convey part 309. For conveying the recovered liquid 207, a syringe, a capillary, a tube, a porous material or the like may be used. For the purpose of actuating the convey of the recovered liquid 207, a pump, a capillary force or the like may be used. The temperature of the chemical substance convey part 309 is preferably a room temperature, but the part may be cooled to no higher than the dew-point temperature of water vapor.

During a voltage is applied to the chemical substance recovery unit 107 with respect to the counter electrode section 106, the chemical substance convey part 309 is preferably separated from the chemical substance recovery unit 107, and most preferably separated physically. In order to separate the chemical substance convey part 309 from the chemical substance recovery unit 107, the chemical substance convey part 309 is preferably made movable. In the recovery step, during a voltage is applied to the chemical substance recovery unit 107 with respect to the counter electrode section 106, the chemical substance convey part 309 may be electrically separated from the chemical substance recovery unit 107.

The chemical substance 202 included in the recovered liquid 207 is preferably detected by a chemical substance detection unit 310. The chemical substance 202 to be detected may be one kind, or two or more kinds. Preferable examples of the chemical substance 202 include ketones, amines, alcohols, aromatic hydrocarbons, aldehydes, esters, organic acid, hydrogen sulfide, methylmercaptan, disulfide and the like, and alkane, alkene, alkyne, diene, alicyclic hydrocarbon, allene, ether, carbonyl, carbanio, protein, polynuclear aromatic, heterocyclic, organic derivative, nucleic acid, ribonucleic acid, antibodies, biotic molecule, metabolites, isoprene, isoprenoid and their derivatives are also preferred. In the recovery step, quantitative determination of the chemical substance 202 is preferably carried out by the chemical substance detection unit 310; however, only the presence of the chemical substance 202 may be detected.

Interfering substances other than the water vapor 201 and the subject substance of detection included in the recovered liquid 207 may be eliminated. In order to eliminate the interfering substance from the recovered liquid 207, a filter or an adsorbent may be used. Alternatively, other elimination methods may be also employed.

In the present Embodiment, at least two steps of the aforementioned injection step to the recovery step may be concurrently carried out. More specifically, for example, the injection step and the first condensate liquid formation step may be carried out concurrently. Alternatively, each of these steps may be carried out in an orderly sequence.

The first charged fine particles 206 and the second charged fine particles 311 may be heated in the present Embodiment. The concentration of the chemical substance 202 may be increased by heating the first charged fine particles 206 and the second charged fine particles 311. For heating the first charged fine particles 206 and the second charged fine particles 311, infrared light is preferably used. When the first charged fine particles 206 and the second charged fine particles 311 are heated with infrared light, it is preferred that a wavelength of the absorption peak of water be used. The infrared light for use in heating the first charged fine particles 206 and the second charged fine particles 311 is preferably not irradiated on the atomizing electrode section 105 and the chemical substance recovery unit 107. The infrared light for use in heating the first charged fine particles 206 and the second charged fine particles 311 is preferably focused.

It is also preferred that the infrared light for use in heating the first charged fine particles 206 and the second charged fine particles 311 be wave guided in the vessel 101. In such a case, an optical waveguide is preferably provided in the vessel 101. It is also preferred that a window of infrared light be provided in a part of the vessel 101. A heater may be also used for heating the first charged fine particles 206 and the second charged fine particles 311.

The chemical substance recovery unit 107, the chemical substance convey part 309 or the chemical substance detection unit 310 is preferably separable from the vessel 101. Although the chemical substance recovery unit 107, the chemical substance convey part 309 or the chemical substance detection unit 310 is preferably washable, it may also be disposable.

In the first charged fine particle production step and/or the second charged fine particle production step, corona discharge may be used, but electrostatic spraying is most preferably used. However, when relative humidity in the sample gas 203 is too low, or when sufficient first condensate liquid 204 is not produced on the outer peripheral surface of the atomizing electrode section 105, the electrostatic spraying may be accompanied by the corona discharge depending on the circumstances. Accordingly, the first charged fine particle production step and/or the second charged fine particle production step are/is not limited to the electrostatic spraying in the present disclosure.

In the first charged fine particle production step and/or the second charged fine particle production step, application of the voltage between the atomizing electrode section 105 and the counter electrode section 106 is preferably regulated depending on the electric current that flows between the atomizing electrode section 105 and the counter electrode section 106. When an electric current no less than the threshold value flows between the atomizing electrode section 105 and the counter electrode section 106, application of the voltage between the atomizing electrode section 105 and the counter electrode section 106 is preferably interrupted, but merely reducing the applied voltage is also acceptable. In addition, when the electric current that flows between the atomizing electrode section 105 and the counter electrode section 106 becomes no greater than the threshold value, the application of the voltage may be resumed.

In order to remove the water vapor 201, the chemical substance 202 or the dopant 205 from the atomizing electrode section 105, the atomizing electrode section 105 is preferably heated. When the atomizing electrode section 105 is heated, a clean gas is preferably injected into the vessel 101. It is preferred that the clean gas does not contain the water vapor 201, chemical substance 202 or dopant 205.

For removing the water vapor 201, chemical substance 202 or dopant 205 by heating the atomizing electrode section 105, a thermoelectric element may be also be utilized. The thermoelectric element is preferably the cooling part 104. Use of the thermoelectric element is convenient since the cooling face and the heating face can be easily inverted. In addition, use of an identical thermoelectric element for the condensation step and for removing the water vapor 201, removing the chemical substance 202 or removing the dopant 205 may allow for miniaturization of the apparatus for analysis. For detecting removal of the water vapor 201, chemical substance 202 or dopant 205, the chemical substance detection unit 310 is preferably used, but use of a chemical substance detection unit other than the chemical substance detection unit 310 is also acceptable.

In order to remove the water vapor 201, chemical substance 202 or dopant 205 from the counter electrode section 106, it is also preferred that the counter electrode section 106 be heated. When the counter electrode section 106 is heated, a clean gas is preferably injected into the vessel 101. It is preferred that the clean gas does not contain the water vapor 201, chemical substance 202 and dopant 205.

For removing the water vapor 201, chemical substance 202 or dopant 205 by heating the counter electrode section 106, a thermoelectric element may be utilized. Use of the thermoelectric element is convenient since the cooling face and the heating face can be easily inverted. For detecting removal of the water vapor 201, chemical substance 202 or dopant 205, the chemical substance detection unit 310 is preferably used, but use of a chemical substance detection unit other than the chemical substance detection unit 310 is also acceptable.

In order to remove the water vapor 201, the chemical substance 202 or the dopant 205 from the chemical substance recovery unit 107, it is also preferable to heat the chemical substance recovery unit 107. When the chemical substance recovery unit 107 is heated, a clean gas is preferably injected into the vessel 101. It is preferred that the clean gas does not contain the water vapor 201, chemical substance 202 and dopant 205.

For removing the water vapor 201, chemical substance 202 or dopant 205 by heating the chemical substance recovery unit 107, a thermoelectric element may be utilized. The thermoelectric element is preferably the second cooling part 108. Use of the thermoelectric element is convenient since the cooling face and the heating face can be easily inverted. In addition, when the same thermoelectric element is used for the recover step, and for removing the water vapor 201, removing the chemical substance 202 or removing the dopant 205, it is possible to miniaturize the apparatus for analysis. The chemical substance detection unit 117 is preferably used for detecting removal of the water vapor 201, chemical substance 202 or dopant 205, but use of a chemical substance detection unit other than the chemical substance detection unit 310 is also acceptable.

### Embodiment 3

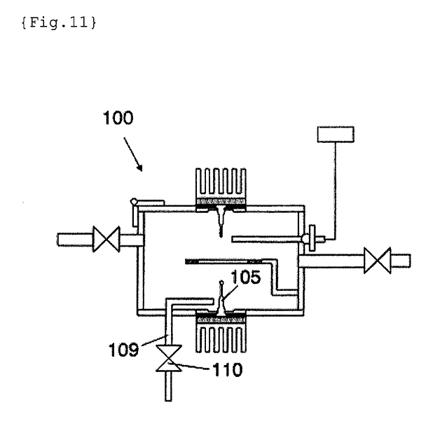

FIG. 11 shows an exemplary schematic diagram illustrating an electrostatic spraying device according to Embodiment 3 of the present disclosure. In FIG. 11, the same reference numerals are given to the identical elements to those in FIG. 1, and their explanation is omitted.

The difference between the present Embodiment and Embodiment 1 lies in a supply port 109 provided in the vicinity of the atomizing electrode section 105. The dopant 205 may be added from the supply port 109 directly to the first condensate liquid 204. A liquid dopant 205 may be supplied to the first condensate liquid 204. To supply a cooled dopant 205 is also acceptable.

### Embodiment 4

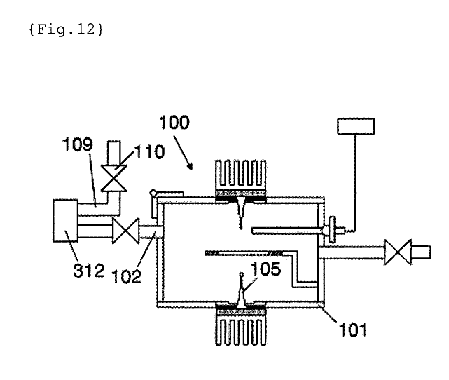

FIG. 12 shows an exemplary schematic diagram illustrating an electrostatic spraying device according to Embodiment 4 of the present disclosure. In FIG. 12, the same reference numerals are given to the identical elements to those in FIG. 1, and their explanation is omitted.

The difference between the present Embodiment and Embodiment 1 lies in a supply port 109 provided in a sample gas generating unit 312. The dopant 205 is supplied from the upstream side of the sample gas generating unit 312. The dopant 205 injected into the vessel 101 together with the sample gas 203. The sample gas generating unit 312 may be a bubbler, a sample bag, a respiratory organ or a circulatory organ of a living body, or the like.

Hereinafter, the present disclosure is explained in more detail by way of Examples, but the following Examples are described merely for the purpose of illustration, and should not be construed as limiting the present disclosure.

### Example 1

The vessel 101 was produced using an aluminum plate having a thickness of 4 mm. The vessel 101 was processed into a rectangular solid of 38 mm×38 mm×18 mm. A part of the vessel 101 was designed to be replaceable with an acrylic resin plate. To design the device such that a transparent material forms a part of the vessel is preferred since the step of forming the condensate liquid and the like can be observed. The inner wall of the vessel 101 was ground to be smooth, whereby the gas adsorption was suppressed.

The vessel 101 was openable and closable by means of the hinge 301.

The injection port 102 was provided to be in communication with the vessel 101. As the injection port 102, a stainless tube having an external diameter of ⅛ inch, and a length of 50 mm was used. The injection port 102 was provided at a position 10 mm away from the bottom face of the vessel 101, to be horizontal with respect to the bottom face of the vessel 101.

An outlet port 103 was provided at the other end of the vessel 101. As the outlet port 103, a stainless steel tube having an external diameter of ⅛ inch, and a length of 50 mm was used. The outlet port 103 provided at a position 4 mm away from the bottom face of the vessel 101, to be horizontal with respect to the bottom face of the vessel 101.

As the cooling part 104, a thermoelectric element was provided at one end of the vessel 101. The cooling part 104 was provided at one site of the vessel 101. The size of the cooling part 104 was 14 mm×14 mm×1 mm. The maximum heat of absorption of the cooling part 104 was 0.9 W, and the maximum temperature difference was 69° C. The cooling face of the cooling part 104 was covered with a ceramics material. Since the ceramics materials have fine relief or porous structure on the surface thereof, an object in contact therewith can be efficiently cooled.

Radiating fins were provided at the cooling part 104 as the heat radiation part 303. The radiating fins of the heat radiation part 303 were produced with aluminum, and the number of the fins was six, and the size of the fins was 16 mm×15 mm×1 mm. A cooling fan (KD1208PTB2-6, SUNON) for promoting heat radiation was provided in the vicinity of the heat radiation part 303.

A thermal protection part 304 was provided between the cooling part 104 and the vessel 101. A rubber film having a thickness of 1 mm was used as the thermal protection part 304. A through-hole was formed at a part of the rubber film for allowing the atomizing electrode section 105 to be penetrated. The through-hole had a diameter of 1 mm.

An atomizing electrode section 105 was provided at one end of the cooling part 104. A stainless steel needle was provided in the vessel 101 as the atomizing electrode section 105. The stainless steel needle had a length of 3 mm, and a maximum diameter of 0.79 mm and a minimum diameter of 0.5 mm. In addition, a sphere having a diameter of 0.72 mm was provided at the tip of the stainless steel needle, whereby the first charged fine particle production step carried out in a stable manner could be permitted. A thermally conductive grease (SCH-20, Sunhayato Corp.) was applied between the atomizing electrode section 105 and the cooling part 104.

In the atomizing electrode section 105, a Teflon circular plate having a diameter of 10 mm and a thickness of 3 mm was provided as an insulating part 305. A recess structure having a diameter of 4 mm and a depth of 1 mm was provided at a central region of the insulating part 305.

The counter electrode section 106 was provided at a position 3 mm away from the tip of the atomizing electrode section 105. As the counter electrode section 106, a toric stainless steel plate having an external diameter of 12 mm, an internal diameter of 8 mm and a thickness of 0.5 mm was used.

A chemical substance recovery unit 107 was provided at the other end of the vessel 101. A stainless steel needle was provided in the vessel 101 as the chemical substance recovery unit 107. The stainless steel needle had a length of 3 mm, a maximum diameter of 0.79 mm and a minimum diameter of 0.5 mm. In addition, the tip of the stainless steel needle was ground to sharpen to be acuminate, whereby efficient recovery of the chemical substances was facilitated.

In the chemical substance recovery unit 107, a Teflon circular plate having a diameter of 10 mm and a thickness of 3 mm was provided as a second insulating part 306. A recess structure having a diameter of 4 mm and a depth of 1 mm was provided at a central region of the second insulating part 306.

A second cooling part 108 was provided at one end of the chemical substance recovery unit 107. The size of the second cooling part 108 was 14 mm×14 mm×1 mm. The maximum heat of absorption of the second cooling part 108 was 0.9 W, and the maximum temperature difference was 69° C. The cooling face of the second cooling part 108 were covered with a ceramics material. Since the ceramics materials have fine relief or porous structure on the surface thereof, an object to be in contact can be efficiently cooled.

Radiating fins were provided at the second cooling part 108 as the second heat radiation part 307. The radiating fins of the second heat radiation part 307 were produced with aluminum, and the number of the fins was six, and the size of the fins was 16 mm×15 mm×1 mm. A cooling fan (KD1208PTB2-6, SUNON) was provided in the vicinity of the second heat radiation part 114 for promoting heat radiation.

A rubber film having a thickness of 1 mm was provided between the second cooling part 108 and the vessel 101 as a second thermal protection part 308. A through-hole was formed at a part of the rubber film for allowing the atomizing electrode section 105 to be penetrated. The through-hole had a diameter of 1 mm.

A thermal conductive grease (SCH-20, Sunhayato Corp.) was applied between the chemical substance recovery unit 107 and the second cooling part 108.

A valve 112a and a valve 112b were provided at the injection port 102 and the outlet port 103, respectively.

Next, exemplary operation procedures of the electrostatic spraying device 100 are explained below.

In the injection step, sample gas 203 was injected from the injection port 102 into the vessel 101. A nitrogen gas containing volatile components from mouse urine was used as the sample gas 203. Method for preparing the sample gas 203 is as follows.

First, 0.2 mL of mouse urine was filled in a 1-mL glass vial. Then, a nitrogen gas feeding port and an outlet port was attached to the vial. A nitrogen gas (purity: 99.99%) was fed from the nitrogen gas feeding port, and sprayed onto the mouse urine. The nitrogen gas employed had passed through a bubbler of 100 mL of pure water. The nitrogen gas containing the volatile components in the mouse urine was taken out from the outlet port, and kept as the sample gas 203. As the dopant 205, 0.3% acetic acid (guaranteed reagent, Cat-No. 017-00256, Wako Pure Chemical Industries, Ltd.) was admixed into the mouse urine.

The injection speed of the sample gas 203 into the vessel 101 was 500 sccm. The temperature of the sample gas 203 was equilibrated to the room temperature (22° C.).

Prior to injection of the sample gas 203 into the vessel 101 in the injection step, the interior of the vessel 101 was filled with a dry nitrogen gas.

In the injection step, excess sample gas 203 was discharged through the outlet port 103.

The interior of the vessel 101 was equilibrated to the ambient pressure in the injection step.

In the first condensate liquid formation step, the atomizing electrode section 105 was cooled to 15° C. by the thermoelectric element.

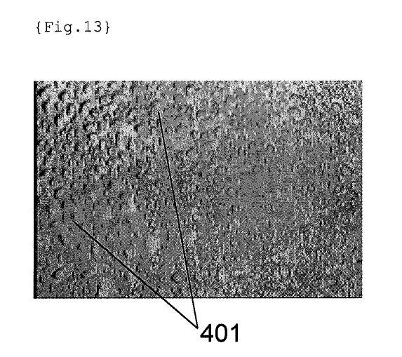

A first condensate liquid 204 was formed on the outer peripheral surface of the atomizing electrode section 105 after 5 seconds following the operation of the thermoelectric element. In the initial stage of formation of the first condensate liquid 204, a droplet having a diameter of no greater than 10 μm was formed. Over the course of time, the droplet grew, and the covering of the entire face of the atomizing electrode section 105 with the first condensate liquid 204 progressed. The formation of the first condensate liquid 204 on the outer peripheral surface of the atomizing electrode section 105 was observed using a microscope (manufactured by KEYENCE Corporation, VH-6300). FIG. 13 shows a micrograph illustrating the state of formation of the first condensate liquid 204 on the outer peripheral surface of the atomizing electrode section 105. As shown in FIG. 13, droplets 401 of the first condensate liquid were formed on the outer peripheral surface of the atomizing electrode section 105 in the first condensate liquid formation step.

Next, in the first charged fine particle production step, a large number of first charged fine particles 206 were produced from the first condensate liquid 204. The first charged fine particle production step was carried out by electrostatic spraying. It should be noted that corona discharge occurs in the initial stage of the electrostatic spraying, which may be involved in the first charged fine particle production step of the present disclosure, as also described in the above Embodiment 1.

In light of stability of the charged fine particles, the first charged fine particles 206 preferably have a diameter of no less than 2 nm and no greater than 30 nm. Although it is preferred that the first charged fine particles 206 solely exist one by one, binding of two or more particles is also acceptable. In the present disclosure, the shape of the first charged fine particles 206 is not limited, and may be spherical, flat, or spindle.

DC of 5 kV was applied between the atomizing electrode section 105 and the counter electrode section 106. The atomizing electrode section 105 was used as a cathode, and the counter electrode section 106 was used as a GND electrode. Although a similar effect could be achieved even though the atomizing electrode section 105 was used as an anode, and the counter electrode section 106 was used as a GND electrode, the first charged fine particle production step was comparatively unstable in this case.

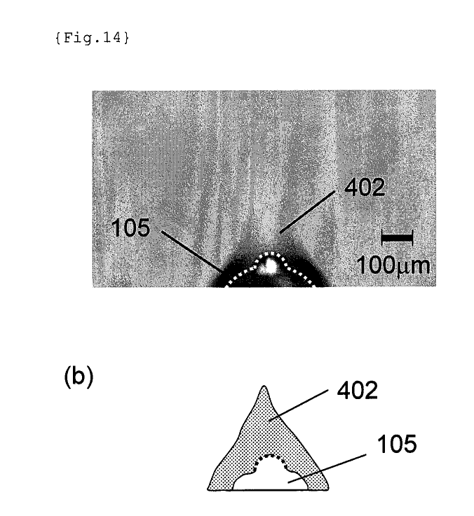

In the first charged fine particle production step, a cone-shaped water column referred to as Taylor cone was formed at the tip of the atomizing electrode section 105. A large number of first charged fine particles 206 containing the chemical substance 202 were released from the tip of the Taylor cone. FIG. 14 shows a view for explaining generation of a Taylor cone 402 and the first charged fine particles 206. The first condensate liquid 204 was conveyed sequentially in the direction toward the tip of the atomizing electrode section 105. As shown in FIG. 14 (a), the Taylor cone 402 was formed at the tip of the atomizing electrode section 105. FIG. 14 (b) shows a traced drawing of the micrograph shown in FIG. 14 (a). The first charged fine particles 206 were released from the tip top of the Taylor cone 402, i.e., a position to which the electric field concentrates. In this Example, the Taylor cone 402 was formed after 7 sec following initiation of injection of the sample gas 203.

In the first charged fine particle production step, the electric current that flowed between the atomizing electrode section 105 and the counter electrode section 106 was monitored. When an excess electric current flowed, application of the voltage between the atomizing electrode section 105 and the counter electrode section 106 was interrupted or the applied voltage was lowered.

In the second charged fine particle production step, the first charged fine particle 206 was mixed with the sample gas 203. For carrying out the second charged fine particle production step, the sample gas 203 was allowed to strike the counter electrode section 106 and the inner wall of the vessel 101. By allowing the sample gas 203 to strike the counter electrode section 106 and the inner wall of the vessel 101, the first charged fine particles 206 can be efficiently mixed with the sample gas 203. The injection speed of the sample gas 203 into the vessel 101 was 500 sccm.

In the recovery step, the first charged fine particles 206 and the second charged fine particles 311 were recovered into the chemical substance recovery unit 107 by an electrostatic force. A voltage of +500 V was applied to the chemical substance recovery unit 107 with respect to the counter electrode section 106. The recovery step was carried out in parallel with the injection step, the first condensate liquid formation step, the first charged fine particle production step, and the second charged fine particle production step. In light of the life span of the first charged fine particles 206 and the second charged fine particles 311, the recovery step is preferably carried out within 10 minutes at the latest following initiation of the first charged fine particle production step and the second charged fine particle production step.

In the recovery step, cold condensation of the first charged fine particles 206 and the second charged fine particles 311 was carried out in the chemical substance recovery unit 107. The temperature of the chemical substance recovery unit 107 was 15° C. After 6 minutes following initiation of the injection step, 1.5 μL of the recovered liquid 207 was obtained in the chemical substance recovery unit 107. The charged fine particles recovered are most preferably liquidified, but may be kept in the atomized form. Also, the first charged fine particles 206 and the second charged fine particles 311 may be dissolved in an aqueous solution or gel.

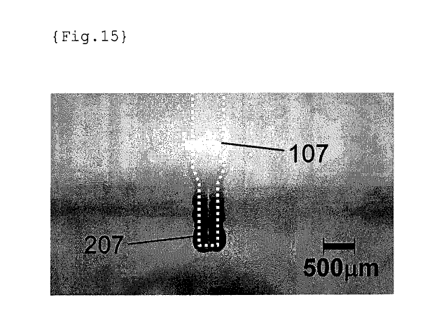

FIG. 15 shows a micrograph of the recovered liquid 207 in the chemical substance recovery unit 107. A droplet of the recovered liquid 207 could be observed on the outer peripheral surface of the chemical substance recovery unit 107.

In the recovery step, the recovered liquid 207 obtained was collected in a volume of 1 μL with a Hamilton syringe (802N 25 μL HAMILTON). The recovered liquid 207 collected was introduced into a gas chromatography apparatus, and the chemical substance 202 was analyzed.

GC-4000 (GL Sciences, Inc.) was used as the gas chromatography apparatus. The analysis column employed was a capillary column (Inert Cap Pure WAX). The capillary column had an internal diameter of 0.25 mm, a length of 30 m, and df of 0.25 μm. The carrier gas was helium. The programmed oven temperature included the initial temperature being 40° C., the rate of temperature elevation being 4° C./min, and the final temperature being 200° C. The injection temperature and the hydrogen flame ionization detector (FID) temperature were 250° C., respectively.

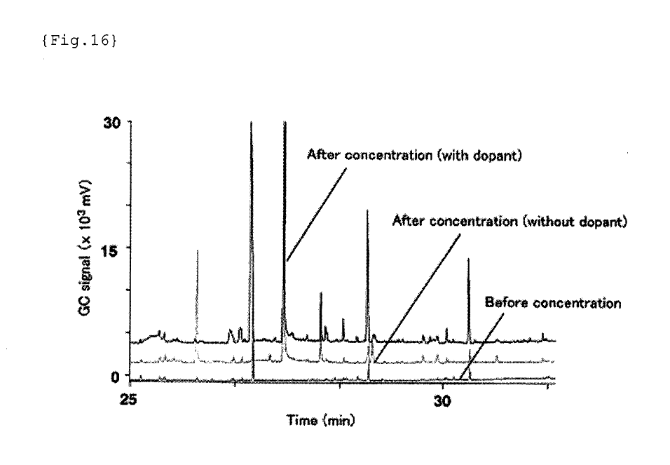

FIG. 16 shows the results of analysis of the recovered liquid 207. In FIG. 16, the chromatogram noted as “before concentration” shows the result of the analysis of the sample gas 203 in a volume of 25 μL. In FIG. 16, the chromatogram noted as “after concentration (without dopant)” shows the result of the analysis of the recovered liquid 207 in a volume of 1 μL, which was obtained by operating the electrostatic spraying device 100 without mixing the dopant 205 with the sample gas 203. In FIG. 16, the chromatogram noted as “after concentration (with dopant)” shows the result of the analysis of the recovered liquid 207 in a volume of 1 μL, which was obtained by mixing the dopant 205 with the sample gas 203, and operating the electrostatic spraying device 100. In FIG. 16, there was a case in which the peak of the chromatogram after concentration (without dopant) was greater than the peak of the chromatogram before concentration. This result suggests that the chemical substance 202 included in the sample gas 203 was concentrated. In FIG. 16, the peak of the chromatogram after concentration (without dopant) was greater than the peak of the chromatogram before concentration. This result suggests that the chemical substance 202 included in the sample gas 203 was concentrated. In FIG. 16, the peak of the chromatogram after concentration (with dopant) was greater than the peak of the chromatogram before concentration. This result suggests that the chemical substance 202 included in the sample gas 203 was concentrated. When the dopant 205 was added to the sample gas 203, some of the chemical substances 202 were more concentrated as compared with the case in which the dopant 205 was not added to the sample gas 203.

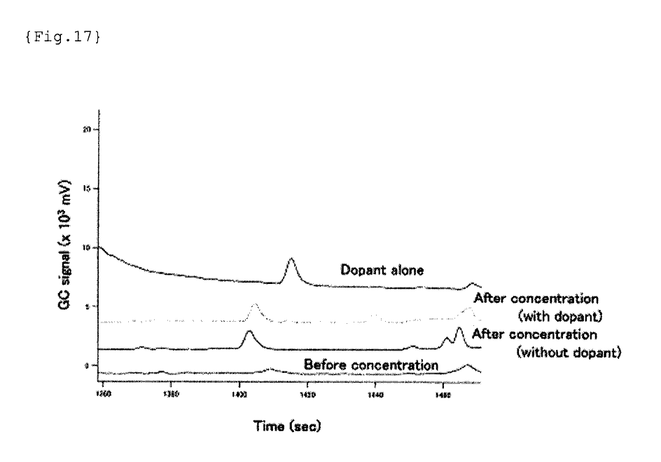

Moreover, FIG. 17 shows an enlarged view illustrating a part of the analytical results shown in FIG. 16. In FIG. 17, the chromatogram of the dopant 205 is presented as a reference. The chemical substances 202 in the sample gas 203 were concentrated by an electrostatic spraying device 100. By mixing the sample gas 203 with the dopant 205, the chemical substances 202 in the sample gas 203 were more efficiently concentrated. When the dopant 205 was mixed into the sample gas 203, the chemical substances 202 in the sample gas 203 was concentrated to 1,250 times.

In the recovery step, the chemical substance recovery unit 107 was detached from the vessel 101. The detached chemical substance recovery unit 107 was washed with methanol.

In the recovery step, the atomizing electrode section 105 was heated in order to remove the chemical substance 202. For heating the atomizing electrode section 105, a thermoelectric element was used. This thermoelectric element was the same as that used in cooling the atomizing electrode section 105 in the first condensate liquid formation step. When the atomizing electrode section 105 was heated, the polarity of the voltage applied to the thermoelectric element was inverted from that in cooling the atomizing electrode section 105.

In the recovery step, removal of the chemical substance 202 from the atomizing electrode section 105 was carried out under an airflow of a dry nitrogen gas. Thus, the chemical substance 202 could be removed from the atomizing electrode section 105 rapidly. The dry nitrogen gas was introduced from the injection port 103.

In the recovery step, electrical neutralization of the chemical substance recovery unit 107 was carried out. The electrical neutralization was carried out by grounding the chemical substance recovery unit 107.

In the first charged fine particle production step and the second charged fine particle production step, the electric current that flowed between the atomizing electrode section 105 and the counter electrode section 106 was monitored. When an excess electric current flowed, application of the voltage between the atomizing electrode section 105 and the counter electrode section 106 was interrupted.

When the case in which the vessel 101 was provided with the case in which the vessel 101 was not provided, the sample gas 203 could be more efficiently concentrated when the vessel 101 was provided.

As demonstrated by this Example, the chemical substance could be concentrated simply and efficiently by the electrostatic spraying device without necessity of using the nebulizer gas and gas for primary ion generation.

### Example 2

In this Example, explanation of the same constitution elements as those in Example 1 is omitted.

In this Example the difference from Example 1 lies in the use of a different type of dopant 205. In this Example, oxygen referred to as having a greater electronic affinity than acetic acid was used as the dopant 205. Additionally, the difference from Example 1 lies in the method of mixing the sample gas 203 with the dopant 205 in this Example. A dopant vessel was utilized for mixing the dopant 205 into the sample gas 203.

Next, exemplary operation procedures of the electrostatic spraying device 100 are explained below.

In the injection step, the sample gas 203 was injected from the injection port 102 into the vessel 101. A nitrogen gas containing volatile components from mouse urine was used as the sample gas 203. Method for preparing the sample gas 203 is as follows. First, 0.2 mL of mouse urine was filled in a 1-mL glass vial. Then, a nitrogen gas feeding port and an outlet port was attached to the vial. A nitrogen gas (purity: 99.99%) was fed from the nitrogen gas feeding port, and sprayed onto the mouse urine. The nitrogen gas employed had passed through a bubbler of 100 mL of pure water. The flow rate of the nitrogen gas was 495 sccm. The nitrogen gas containing the volatile components in the mouse urine was taken out from the outlet port, and kept as the sample gas 203.

The oxygen gas was mixed into the sample gas 203 by the dopant vessel. The flow rate of the oxygen gas was 5 sccm.

The temperature of the sample gas 203 and the dopant 205 was equilibrated to the room temperature (22° C.).

Prior to injection of the sample gas 203 into the vessel 101 in the injection step, the interior of the vessel 101 was filled with a dry nitrogen gas.

In the injection step, the excess sample gas 203 was discharged through the outlet port 103.

The interior of the vessel 101 was equilibrated to the ambient pressure in the injection step.

In the first condensate liquid formation step, the atomizing electrode section 105 was cooled to 15° C. by the thermoelectric element.

A first condensate liquid 204 was formed on the outer peripheral surface of the atomizing electrode section 105 after 5 seconds following the operation of the thermoelectric element. In the initial stage of formation of the first condensate liquid 204, a droplet having a diameter of no greater than 10 μm was formed. Over the course of time, the droplet grew, and the first condensate liquid 204 covered the entire face of the atomizing electrode section 105.

Next, in the first charged fine particle production step, a large number of first charged fine particles 206 were produced from the first condensate liquid 204. The first charged fine particle production step was carried out by electrostatic spraying. It should be noted that corona discharge occurs in the initial stage of the electrostatic spraying, which may be involved in the first charged fine particle production step of the present disclosure, as also described in the above Embodiment 1.

In light of the stability of the charged fine particles, the first charged fine particles 206 preferably have a diameter of no less than 2 nm and no greater than 30 nm. Although it is preferred that the first charged fine particles 206 solely exist one by one, binding of two or more particles is also acceptable. In the present disclosure, the shape of the first charged fine particles 206 is not limited, and may be spherical, flat, or spindle.

DC of 5 kV was applied between the atomizing electrode section 105 and the counter electrode section 106. The atomizing electrode section 105 was used as a cathode, and the counter electrode section 106 was used as a GND electrode. Although a similar effect could be achieved even though the atomizing electrode section 105 was used as an anode, and the counter electrode section 106 was used as a GND electrode, the first charged fine particle production step was comparatively unstable in this case.

In the first charged fine particle production step, a cone-shaped water column referred to as Taylor cone was formed at the tip of the atomizing electrode section 105. A large number of first charged fine particles 206 containing the chemical substance 202 were released from the tip of the Taylor cone. The first charged fine particles 206 were released from the tip top of the Taylor cone 402, i.e., a position to which the electric field concentrates. In this Example, the Taylor cone 402 was formed after 7 sec following initiation of injection of the sample gas 203.

In the first charged fine particle production step, the electric current that flowed between the atomizing electrode section 105 and the counter electrode section 106 was monitored. When an excess electric current flowed, application of the voltage between the atomizing electrode section 105 and the counter electrode section 106 was interrupted or the applied voltage was lowered.

In the second charged fine particle production step, the first charged fine particle 206 was mixed with the sample gas 203. For carrying out the second charged fine particle production step, the sample gas 203 was allowed to strike the counter electrode section 106 and the inner wall of the vessel 101. By allowing the sample gas 203 to strike the counter electrode section 106 and the inner wall of the vessel 101, the first charged fine particles 206 can be efficiently mixed with the sample gas 203. The injection speed of the sample gas 203 into the vessel 101 was 500 sccm.

In the recovery step, the first charged fine particles 206 and the second charged fine particles 311 were recovered into the chemical substance recovery unit 107 by an electrostatic force. A voltage of +500 V was applied to the chemical substance recovery unit 107 with respect to the counter electrode section 106. The recovery step was carried out in parallel with the injection step, the first condensate liquid formation step, the first charged fine particle production step, and the second charged fine particle production step. In light of the life span of the first charged fine particles 206 and the second charged fine particles 311, the recovery step is preferably carried out within 10 minutes at the latest following initiation of the first charged fine particle production step and the second charged fine particle production step.

In the recovery step, cold condensation of the first charged fine particles 206 and the second charged fine particles 311 was carried out in the chemical substance recovery unit 107. The temperature of the chemical substance recovery unit 107 was 15° C. After 6 minutes following initiation of the injection step, 1.5 μL of the recovered liquid 207 was obtained in the chemical substance recovery unit 107. The charged fine particles recovered are most preferably liquidified, but may be kept in the atomized form. For liquidification, the charged fine particles may be subjected to cold condensation, or may be dissolved in an aqueous solution or gel.

In the recovery step, the recovered liquid 207 obtained was collected in a volume of 1 μL with a Hamilton syringe (802N 25 μL HAMILTON). The recovered liquid 207 collected was introduced into a gas chromatography apparatus, and the chemical substance 202 was analyzed.

GC-4000 (GL Sciences, Inc.) was used as the gas chromatography apparatus. The analysis column employed was a capillary column (Inert Cap Pure WAX). The capillary column had an internal diameter of 0.25 mm, a length of 30 m, and df of 0.25 μm. The carrier gas was helium. The programmed oven temperature included the initial temperature being 40° C., the rate of temperature elevation being 4° C./rain, and the final temperature being 200° C. The injection temperature and the hydrogen flame ionization detector (FID) temperature were 250° C., respectively.

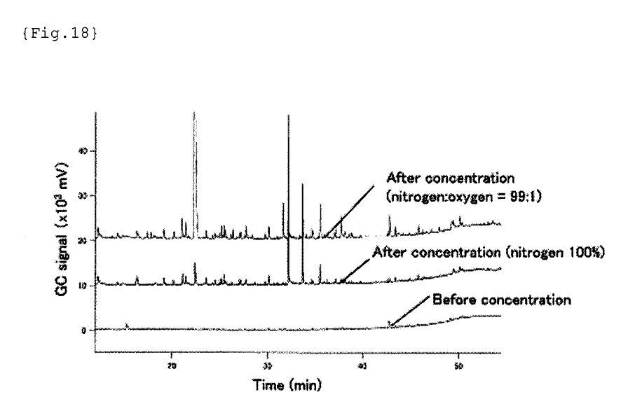

The results of analysis of the recovered liquid 207 are shown in FIG. 18. In FIG. 18, the chromatogram noted as “before concentration” shows the result of the analysis of the sample gas 203 in a volume of 25 μL, and the chromatogram noted as “after concentration (nitrogen 100%)” shows the result of the analysis of the recovered liquid 207 in a volume of 1 μL, which was obtained by operating the electrostatic spraying device 100 without mixing the dopant 205 with the sample gas 203. Moreover, in FIG. 18, the chromatogram noted as “after concentration (nitrogen:oxygen=99:1)” shows the result of the analysis of the recovered liquid 207 in a volume of 1 μL, which was obtained by mixing the dopant 205 with the sample gas 203, and operating the electrostatic spraying device 100.

In FIG. 18, there was a case in which the peak of the chromatogram after concentration (nitrogen 100%) was greater than the peak of the chromatogram before concentration. This result suggests that the chemical substance 202 included in the sample gas 203 was concentrated. Although the peak of the chromatogram after concentration (nitrogen 100%) was greater than the peak of the chromatogram before concentration, this result suggests that the chemical substance 202 included in the sample gas 203 was concentrated. In addition, although the peak of the chromatogram after concentration (nitrogen:oxygen=99:1) was greater than the peak of the chromatogram before concentration, this result suggests that the chemical substance 202 included in the sample gas 203 was concentrated.

When the dopant 205 was added to the sample gas 203, some of the chemical substances 202 were more concentrated as compared with the case in which the dopant 205 was not added to the sample gas 203.

When the dopant 205 was mixed into the sample gas 203, the chemical substances 202 in the sample gas 203 was concentrated to 1,700 times.

From the foregoing description, many modifications and other embodiments of the present disclosure are apparent to persons skilled in the art. Accordingly, the foregoing description should be construed merely as an illustrative example, which was provided for the purpose of teaching best modes for carrying out the present disclosure to persons skilled in the art. Details of the construction and/or function of the present disclosure can be substantially altered without departing from the spirit thereof.

### INDUSTRIAL APPLICABILITY

The sample gas concentration method according to the present disclosure is applicable to mass spectrometers that enable simple and efficient ultramicro analyses. Utilization for environment, foods, accommodation units, automobiles, security fields and the like can be effected in, for example, apparatuses for analyzing biomolecules, apparatuses for analyzing atmospheric pollutants, and the like. Furthermore, it can be utilized for breath diagnostic apparatuses, stress measuring instruments etc., in the medical field, health care field and the like.

We claim:

1. A chemical substance concentration method carried out using an electrostatic spraying device, the electrostatic spraying device comprising a vessel; an injection port of a sample gas in communication with the vessel; a cooling part provided at one end of the vessel; an atomizing electrode section provided at one end of the cooling part; a counter electrode section provided inside the vessel;
a chemical substance recovery unit provided at the other end of the vessel; and a supply port of a dopant in communication with the vessel, in the electrostatic spraying device:
the sample gas comprising water vapor and a chemical substance; the chemical substance being capable of forming a condensate liquid together with the water vapor at a temperature below the dew-point of the water vapor; the dopant being a substance that is dissolved into the condensate liquid; and
the electric affinity of the dopant being greater than the electronic affinity of water,
said method comprising:
an injection step for injecting the sample gas from the injection port to the vessel;
a first condensate liquid formation step for forming a first condensate liquid from the sample gas on the outer peripheral surface of the atomizing electrode section by cooling the atomizing electrode section with the cooling part;
a supplying step for supplying the dopant from the supply port to the vessel;
a dopant cooling step for cooling the dopant on the outer peripheral surface of the atomizing electrode section;
a dissolving step for dissolving the dopant in the first condensate liquid;
a charged fine particle production step for producing charged fine particles from the first condensate liquid by applying a voltage between the atomizing electrode section and the counter electrode section; and
a recovery step for recovery of the charged fine particle into the chemical substance recovery unit by applying a voltage between the counter electrode section and the chemical substance recovery unit.

2. The chemical substance concentration method according to claim 1, wherein the dopant is a polar organic compound.

3. The chemical substance concentration method according to claim 1, wherein the dopant is an organic acid.

4. The chemical substance concentration method according to claim 1, wherein the dopant is acetic acid.

5. The chemical substance concentration method according to claim 1, wherein the dopant is oxygen.

6. The chemical substance concentration method according to claim 1, wherein the concentration of the dopant in the first condensate liquid is higher than the concentration of the chemical substance in the first condensate liquid.

7. The chemical substance concentration method according to claim 1, wherein the vessel has a barrier at a position such that the sample gas strikes the barrier.

8. The chemical substance concentration method according to claim 1, wherein the sample gas comprises a polar organic solvent.

9. The chemical substance concentration method according to claim 1, wherein the chemical substance is a polar organic compound.

10. The chemical substance concentration method according to claim 1, wherein the chemical substance is a volatile organic compound.

11. The chemical substance concentration method according to claim 1, wherein the charged fine particles are heated by infrared light.

12. The chemical substance concentration method according to claim 1 or 11, wherein the vessel is provided with an optical waveguide.

13. The chemical substance concentration method according to claim 1, wherein the electrostatic spraying device is provided with a chemical substance detection unit.

14. A chemical substance concentration method
an injection step for injecting a sample gas into a vessel;
a first condensate liquid formation step for forming a first condensate liquid from the sample gas on the outer peripheral surface of an atomizing electrode section;
a supplying step for supplying a dopant into the vessel;
a dopant cooling step for cooling the dopant on the outer peripheral surface of the atomizing electrode section;
a dissolving step for dissolving the dopant in the first condensate liquid;
a charged fine particle production step for producing charged fine particles from the first condensate liquid by applying a voltage between the atomizing electrode section and a counter electrode section; and
a recovery step for recovery of the charged fine particle into a chemical substance recovery unit by applying a voltage between the counter electrode section and the chemical substance recovery unit.

15. The chemical substance concentration method according to claim 1, wherein the first condensate liquid formation step includes cooling the atomizing electrode section utilizing a cooling part.

16. The chemical substance concentration method according to claim 14, wherein the dopant is provided from the supply port to the vessel;

17. The chemical substance concentration method according to claim 14, wherein the dopant is a polar organic compound.

18. The chemical substance concentration method according to claim 14, wherein the dopant is an organic acid.

19. The chemical substance concentration method according to claim 14, wherein the dopant is acetic acid.

20. The chemical substance concentration method according to claim 14, wherein the dopant is oxygen.

21. The chemical substance concentration method according to claim 14, wherein the concentration of the dopant in the first condensate liquid is higher than the concentration of the chemical substance in the first condensate liquid.

22. The chemical substance concentration method according to claim 14, wherein the vessel has a barrier at a position such that the sample gas strikes the barrier.

23. The chemical substance concentration method according to claim 14, wherein the sample gas comprises a polar organic solvent.

24. The chemical substance concentration method according to claim 14, wherein the chemical substance is a polar organic compound.

25. The chemical substance concentration method according to claim 14, wherein the chemical substance is a volatile organic compound.

26. The chemical substance concentration method according to claim 14, wherein the charged fine particles are heated by infrared light.

27. The chemical substance concentration method according to claim 14, wherein the vessel is provided with an optical waveguide.

28. The chemical substance concentration method according to claim 14, wherein the electrostatic spraying device is provided with a chemical substance detection unit.
